(19) United States
(12) Patent Application Publication
(10) Pub. No.: US 2014/0344261 A1
(43) Pub. Date: Nov. 20, 2014

(54) METHOD AND SYSTEM FOR ANALYZING A REQUEST

(71) Applicant: ChaCha Search, Inc, Carmel, IN (US)

(72) Inventors: Chris Navta, Indianapolis, IN (US); Jeremy Elroy, Indianapolis, IN (US); Jeffrey Jockisch, Westfield, IN (US); Rich Loomis, Fishers, IN (US); Eugene M O'Donnell, Fishers, IN (US)

(73) Assignee: ChaCha Search, Inc, Carmel, IN (US)

(21) Appl. No.: 14/285,208

(22) Filed: May 22, 2014

Related U.S. Application Data
(60) Provisional application No. 61/825,189, filed on May 20, 2013.
(60) Provisional application No. 61/827,294, filed on May 24, 2013.

(51) Int. Cl. G06F 17/30

(52) U.S. Cl. CPC G06F 17/30867
USPC 707/723; 707/741; 707/722

(57) ABSTRACT

A system and method for associating metadata such as a category, topic, tag, or named entity with an item is described. Metadata such as a named entity and a category associated with an item such as a search request may be used to select an item used to process a request. Metadata associated with an item may be used to index items such as responders, resources, etc. used to process an item and may be used to establish a prioritized selection of items.

### BACKGROUND

1. Field of the Invention

The present invention is related to use of sponsored search results and human assisted search.

2. Description of the Related Art

In a system for responding to a request it is often desirable to assign a category to a request. Assignment of a category to a query may be used for various purposes. For example, a category assigned to a query may be used to interpret a meaning associated with a word or phrase indicated in a query, or a category may be used to direct a query to an appropriate destination such as a search engine, a human assistant, etc. A category assigned to a query may be used to select search resources such as web pages, search engines, indexes, etc. which may be used to perform a search responsive to a request.

Assignment of a category to a request may be done in various ways. A person submitting a request may be required to assign a category to a request, a person receiving a request may assign a category to a request, an automated analysis may assign a category to a request, and/or any combination thereof. While categorization of a request may have many benefits, it may have unwanted consequences. For example, a person such as Ronald Reagan might be associated with the categories ‘Politics’ and ‘Actors’. A system analyzing a query including the keyword or “named entity” Ronald Reagan would not necessarily be able to assign a specific category to the query, or might assign an incorrect category to the query. In such an instance, a system might respond poorly to a query due to the hierarchical nature of categorization.

An alternate approach to hierarchical categorization of a query is that of tagging. Tags are words which are associated with a query but have no relationship to each other. For example, in a hierarchical categorization, a parent to child relationship might exist between the category Sports and Basketball because basketball is a type of sport. Similarly, Basketball and NBA might have the same relationship. However, a category such as NCAA might apply to many types of sports and might not be easily added at a particular level of the taxonomic tree. Tags have no such issue since there is no implied relationship of generality or specificity between tags. Thus a query with a particular keyword might be associated with the tags ‘Sports’, ‘NCAA’ and ‘Football’ without necessarily being classified as Sports>NCAA>Football. Tags many have associated weaknesses as well. It is often difficult to determine a dominant meaning or context of a query if multiple tags are associated with a query. If tags are composed of user-generated phrases, equivalent tags may be associated with a query which may cause an incorrect response to a query.

In light of these and other problems, a method and system of analyzing a request which overcomes the deficiencies of prior systems would be greatly appreciated.

### SUMMARY

A query may be associated with a named entity. A named entity is a noun phrase which refers to a specific person, place, or thing. A named entity may be associated with a tag. A tag associated with a named entity may define a class which is of variable specificity. An item may be associated with a named entity. If an item associated with a named entity is not found, an item associated with a progressively less specific or ‘granular’ tag may be selected for a query or request.

A table of named entities may be maintained which includes synonyms of a named entity. An index of items may be associated with tags or topics associated with a named entity. Named entities may be determined based on a database which is created by a person or ‘curator’. A database of named entities may be determined based on analysis of a corpus of documents such as queries, web pages, publications, data feeds, and/or other resources. A database of named entities may be associated with a category which may influence whether a named entity is detected. Mathematical and/or statistical properties such as proximity, word frequency, inverse word frequency, and word count may be used to select potential named entities. An action of a responder may be used to determine whether a named entity is indicated in a request.

A category may be associated with a query. A category of a query may be determined based on an analysis of a corpus of queries. A predictive filter such as a Bayesian filter may be implemented which determines a probability that a query is associated with a category. A query may be associated with a category if no named entities are found to be present in a query.

A topic associated with a named entity may be assigned a value or weight which may indicate specificity of a topic. A more specific topic may be given greater weight in selection of an item for a request. A responder for a request may be selected based on a rating or ranking of a responder for a named entity, topic, and/or category of a request. Priority may be given to a more specific topic as determined by a granularity value or weight of a topic. If a named entity of a query is associated with a topic and a named entity of a responder is associated with the topic, the responder may be more likely to be selected for the query. If a responder is associated with or registered for a named entity, other named entities associated with a topic of the named entity may be suggested to the responder as named entities for which to receive requests.

While a human person or responder has been used for the purposes of illustration other items such as search results, search resources, advertisements, users, profiles, requests and/or any other items which may be tracked in a system database may be rated and ranked for a query based on tags, topics or categories associated with a query.

### BRIEF DESCRIPTION OF THE DRAWINGS

Aspects and advantages of the disclosure will become apparent and more readily appreciated from the following description of the embodiments, taken in conjunction with the accompanying drawings, of which:

FIG. 1 is a block diagram of an exemplary system embodiment.

FIG. 2 illustrates a database for requests.

FIG. 3 illustrates a database for users.

FIG. 4 illustrates a database for responders.

FIG. 5 illustrates a database for resources.

FIG. 6 illustrates a database for named entities.

FIG. 7 is a flowchart of processing a query.

FIG. 8 is a flowchart of tagging a request.

FIG. 9 is a flowchart for selecting a responder.

FIG. 10 is a Graphical User Interface (GUI) for processing a request.

FIG. 11 is a GUI for responding to a request.

FIG. 12 is a block diagram of an exemplary system embodiment.

FIG. 13 illustrates a database for requests.

FIG. 14 illustrates a database for users.

FIG. 15 illustrates a database for responders.

FIG. 16 illustrates a database for resources.

FIG. 17 is a flowchart of processing a query

FIG. 18 is a flowchart of processing a factual query related to a database

FIG. 19 is a flowchart of processing a resource to create question and answer pairs.

FIG. 20 is a GUI for query entry.

FIG. 21 is a GUI for responding to a query using a data feed and/or temporal data.

FIG. 22 is a GUI for resolution of anaphora.

FIG. 23 is a GUI for selection of answers.

FIG. 24 is a GUI for responding to a request based on answers extracted from resources.

FIG. 25 illustrates content of an exemplary web page used to generate a response.

FIG. 26 is a GUI for providing an answer from a restricted resource.

### DETAILED DESCRIPTION OF THE PREFERRED EMBODIMENTS

Reference will now be made in detail to the present embodiments discussed herein. Examples are illustrated in the accompanying drawings, wherein like reference numerals refer to the like elements throughout. The embodiments are described below to explain the disclosed system and method by referring to the figures. It will nevertheless be understood that no limitation of the scope is thereby intended, such alterations and further modifications in the illustrated device, and such further applications of the principles as illustrated therein being contemplated as would normally occur to one skilled in the art to which the embodiments relate. As used herein, words importing the singular shall include the plural and vice versa unless specifically counter indicated.

A system is provided which includes a user system for submitting a query and receiving a response, a search server receiving queries, a database storing information of queries, search results, searchers, users, resources and other information, a guide system receiving a query and providing a search result, and a sponsor system providing sponsored answers.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A first layer may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources.

A third layer of processing of a query may include a human assistant who responds to the query or “searcher”. A searcher may receive an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services.

As used herein, a “request” means a request for information, products, and/or services. A request or search request or query may include various types of media, and may be provided by any user system which may establish communication with a server and/or other devices associated with a search service. A request may be referred to as a “search request”, “search query”, or “query”.

A “user” is a person who submits a request and may receive any type of information responsive to a request. A user may be any person or entity. A “guide” is a person who assists in processing a request. A guide may be referred to as a “responder”, “provider”, “searcher”, “human searcher”, “expediter”, “transcriber”, “specialist” or “generalist”. Guides may be assigned various roles. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role. A user may be a guide.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc.

A human assistant such as an expediter or responder may select a search result associated with a previous query and/or an automated resource. A search result selected by a human assistant may be indicated as a sponsored result and/or an organic result. A human assistant may be presented with sponsored results, organic results, and/or a mixture of organic and sponsored results. An expediter may be associated with a sponsor, and may be presented with sponsored results associated with the sponsor.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide and/or a search system may include conversion of text to speech and speech to text. Any type of media which can be sent and/or received using a communication system may be part of a communication session. A communication session may be conducted using any or all communication services associated with a user, a guide, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

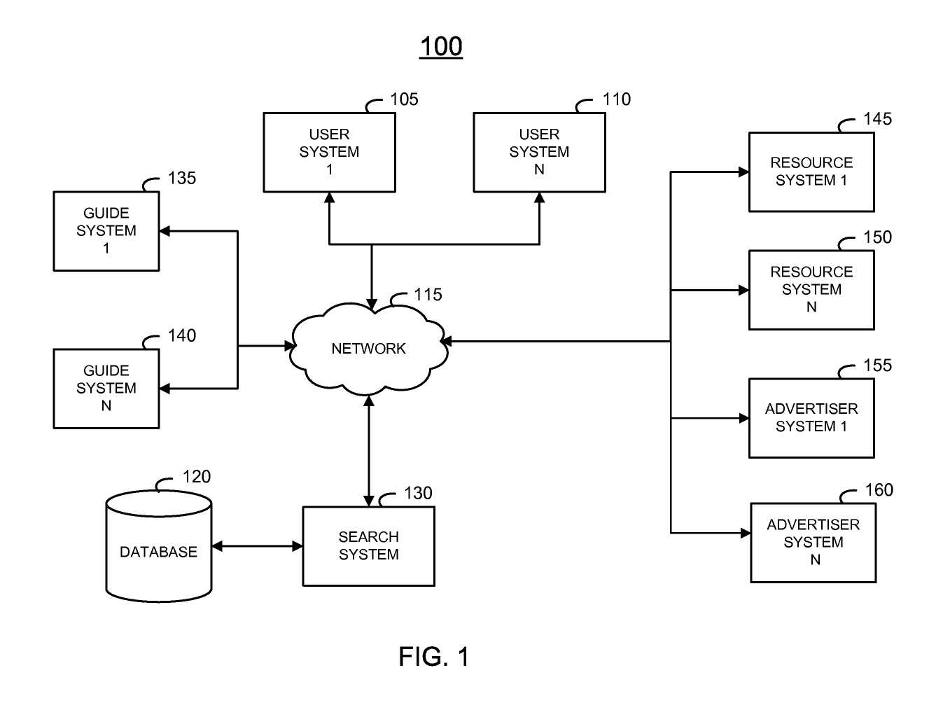

As illustrated in FIG. 1, system 100 includes user systems 105, 110, a network 115 such as the Internet, a search system 130, a database 120, which may comprise various records, guide systems 135, 140, resource systems 145, 150, and advertiser systems 155, 160.

While only a few systems associated with a user, a resource, an advertiser and a guide are depicted in FIG. 1 it is within the scope of the disclosure for multiple systems for a user, resource, sponsor and guide to be utilized. In particular it is envisioned that many user, resource, sponsor and guide systems may be implemented. The search system 130 may be a composed of many components as described further herein.

Any user system (e.g. the user system 105) can be used, to submit a request to the search system 130 and/or receive a result and/or other information. Any user system may receive a response, and/or may provide compensation to the search system 130.

The network 115 may be a global public network of networks (i.e., the Internet) and/or may consist in whole or in part of one or more private networks and communicatively couples the user systems 105, 110, the guide systems 135, 140, the resource systems 145, 150 and the advertiser systems 155, 160 with the other components of the system such as the search system 130, and the database 120. The network 115 may include one or more wireless networks which may enable wireless communication between the various elements of the system 100. For example, the search system 130 may receive messages which may be routed via a wireless network controlled by a wireless service to the user systems 105, 110. A wireless service may receive messages from the guide systems 135, 140 via a wireless network which is a part of the network 115, and provide the messages to the search system 130 via an internet connection which is part of the network 115. Similarly a voice communication via wired and/or wireless communication might be established between any elements of the system 100.

The search system 130 allows interaction to occur among the user systems 105, 110, the guide systems 135, 140, the resource systems 145, 150 and the sponsor systems 155, 160. For example, a request can be transmitted from the user system 105 to the search system 130, which may provide information obtained from the database 120, which may include an advertisement provided by the advertiser system 155 to the user system 105. Similarly, a search result from a searcher operating the guide system 135 and/or the resource system 145 might be routed to the search system 130, which might process the search result, formulate a response and provide a message to the user system 105. Any type of communication between users, resources, sponsors and/or guides may be mediated and/or facilitated by the search system 130, and/or other elements of the system 100.

The search system 130 is communicatively coupled with the database 120. As will be described herein in further detail below, the database 120 includes data that is processed in association with operation of the embodiments. Although FIG. 1 illustrates the database 120 as a separate component of the system, the database 120 may be integrated with the search system 130. Further, the records maintained in the database 120 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 120 may reside in any suitable elements of the system 100. Any or all elements of the system 100 may include any or the entirety of the database 120.

The user systems 105, 110, the guide systems 135, 140, the resource systems 145, 150, the advertiser systems 155, 160 and the search system 130 may include equipment, software, systems and personnel required to send and/or receive messages between a user system 105, 110, the guide systems 135, 140, the resource systems 145, 150 the advertiser systems 155, 160 and/or the search system 130 using the network 115. The database 120 includes information which may allow the search system 130 to establish communication between any or all of the elements of the system 100.

A user system, a guide system, a resource system, a resource system and/or a search system may be a desktop, portable, or tablet PC or Mac®, a mobile phone, a smart phone, a PDA, a server system, a landline phone, a specialized communication terminal, a terminal connected to a mainframe, or any other communication hardware and/or system. The search system 130 may include one or more servers, computers, etc. For example, servers such as the PowerEdge® 2900 by Dell, or the BladeCenterJS22 by IBM, or equivalent systems might be used to implement elements of the search system 130. The search system 130 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, guide systems, sponsor systems and/or to implement the search system 130.

A user may be identified by the search system 130. When a user system, such as the user system 105, establishes a communication session with the search system 130, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 105 and a resource system, a guide system, a sponsor system and/or the search system 130. Information such as a keyword, a category, a user profile, a request, a result, etc., may be associated with a user. A user may be required to provide profile information to the search system 130. A user may elect to receive requests from the search system 130. Parameters and/or attributes may be associated with a resource as will be further described herein below. Information of a user may be stored in the database 120.

A guide may be required to register with the search system 130. As part of a registration process, at least one communication method is associated with a guide. In at least one embodiment, a guide may register with the search system 130 and establish a username and password which are associated with the guide. A guide may login to the search system 130 using a web browser functionality of the guide system 135 in order to communicate with the search system 130. Multiple communication services may be associated with a guide and may allow a communication session to be established between a guide system such as the guide system 135 and a user system, a resource system, a sponsor system, and/or the search system 130. Multiple identifiers of a guide may be associated with each other. Information such as IM credentials, an email address, a phone number, a URL, a username, etc., of a guide may be identified which may allow the search system 130 to establish a communication session between a guide system and a user system, a resource system, a sponsor system and/or the search system 130.

When a guide registers with the search system 130 the guide may be associated with one or more keywords, categories, profiles, and/or other information. Information associated with a guide may be stored in the database 120 and may be used for various purposes. Information associated with a guide may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 130. For example, a guide may be assigned to a role such as translator, transcriber, expediter, generalist, specialist, auditor, etc. A guide may be registered by a sponsor. A sponsor may provide compensation to a sponsored guide.

An advertiser may be required to register with the search system 130. As part of a registration process, at least one communication method is associated with an advertiser. In at least one embodiment, a sponsor may register with the search system 130 and establish a username and password which are associated with the advertiser. An advertiser may login to the search system 130 using a web browser functionality of the sponsor system 155 in order to communicate with the search system 130. Multiple communication services may be associated with an advertiser and may allow a communication session to be established between an advertiser system such as the advertiser system 155 and a user system, a resource system, a guide system, and/or the search system 130. Multiple identifiers of an advertiser may be associated with each other. Information such as IM credentials, an email address, a phone number, a URL, a username, etc., of a sponsor may be identified which may allow the search system 130 to establish a communication session between an advertiser system and a user system, a guide system, a resource system and/or the search system 130.

When an advertiser registers with the search system 130 the advertiser may be associated with one or more keywords, categories, profiles, and/or other information. Information associated with a sponsor or advertiser may be stored in the database 120 and may be used for various purposes. Information associated with an advertiser may be used to rank requests, resources, results, advertisements, guides and/or other information which may be presented to the sponsor. In at least one embodiment, payment information is associated with an advertiser. An advertiser may provide payment information which may be used to compensate the search system 130 for advertisements and/or advertised answers provided to a user. An advertiser may designate a guide associated with an advertiser, and may provide registration information associated with the advertiser guide. An advertiser may provide information associated with a resource. An advertiser may designate conditions for accessing a resource provided by the advertiser.

Records may be maintained in the database 120 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

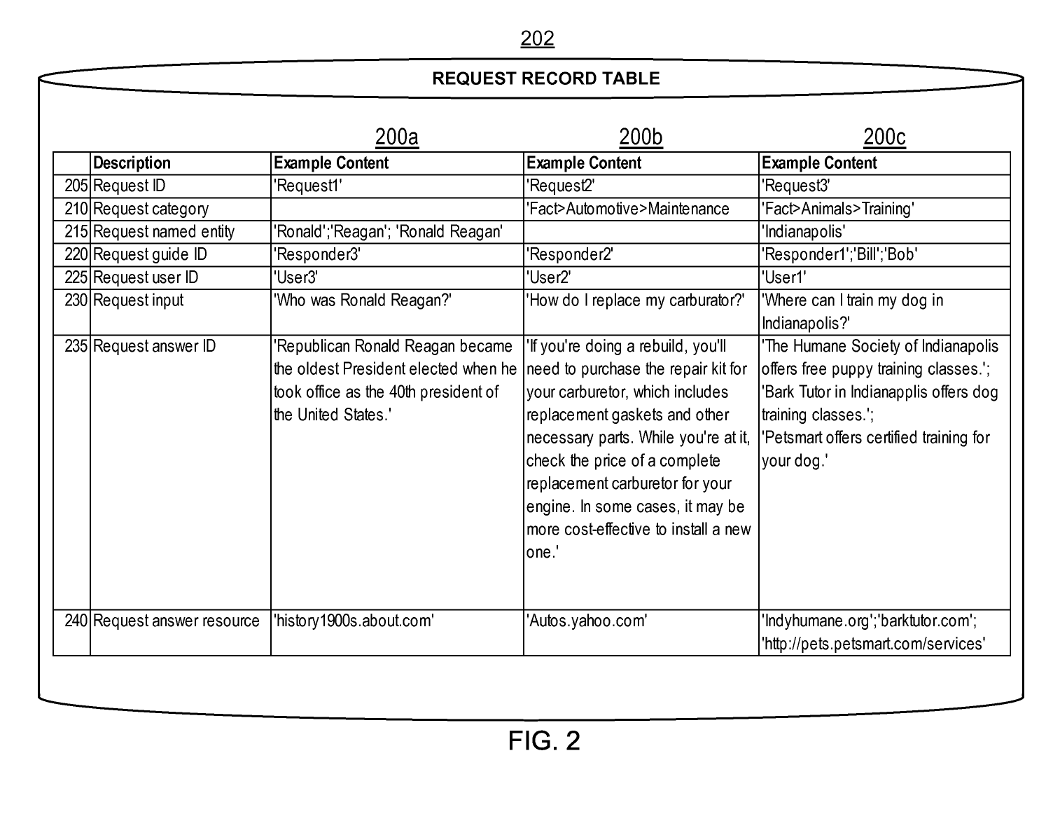

As illustrated in FIG. 2 an exemplary request record table 202 which may comprise a number of request records is provided. One or more request records may be associated with or resident in the database 120 (FIG. 1). The request record table 202 may include information of requests which may be processed. The request records 200 may include a request ID field 205, a request category field 210, a request named entity field 215, a request guide ID field 220, a request user ID field 225, a request input field 230, a request answer ID field 235, and a request answer resource field 240.

The request ID field 205 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 205. In at least one embodiment, a random number is indicated in the request ID field 205. Using the example in FIG. 2, ‘Request1’ is the request ID associated with the request record 200a.

The request category field 210 may include information of a category associated with a request. Information indicated in the request category field 210 may be used to select an item associated with a request. For example, a category and/or type associated with a request may be used to rank guides or responders who may be associated with the type of request. Likewise, a category associated with a request may be used to rank requests which may be presented to a guide. A category associated with a request may be determined based on factors such as keywords of a query, a profile of a user, a selection of a guide, a user history, etc. A category associated with a system taxonomy may be indicated in the request category field 210. A category may be associated with a request automatically and/or using the assistance of a person. Using the example in FIG. example in FIG. 2, ‘Request2’ may be categorized as ‘Fact>Automotive>Maintenance’ as indicated in the request record 200b. This may indicate that a person or item associated with the category ‘Fact>Automotive>Maintenance’ may have a higher ranking for responding to ‘Request2’. A category of a request may be associated with a user submitting the request. Content of a request such as a keyword, etc. may be used to assign a category or type to a request. A category may be assigned based on a Bayesian filter, or other automated learning system.

The request named entity field 215 may include information of a number of named entities of a request. Content of the named entity field 215 may be used to obtain information for determining a resource, responder, guide, and/or other item for a query. A resource may be chosen based on a ranking of resources for a named entity of a query. Using the example in FIG. 2, ‘Ronald’; ‘Reagan’; ‘Ronald Reagan’ associated with 200a are possible named entities of the query ‘Who was Ronald Reagan?’

The request guide ID field 220 may include information of a number of guides associated with a request. Content of the request guide ID field 220 may be used to obtain information of a guide. For example, a guide ID might point to a responder record. If a person is selected for a request, elects to receive a request, provides a response to a request, reviews a result of a request and/or completes a request, an identifier of the person may be indicated in the request guide ID field 215. Using the example in FIG. 2, ‘Responder2’ is associated with ‘Request2’. This may for example indicate that ‘Request2’ has been processed by ‘Responder2’.

The request user ID field 225 may include information of a number of users associated with a request. A request user ID may be for example a pointer to a user record associated with a request. If a user submits a request, a user ID of a user may be added to the request user ID field 225. Using the example illustrated in FIG. 2, ‘Request3’, is associated with ‘User1’ as indicated in the user record 200c. This may indicate that ‘User1’ has submitted ‘Request3’.

The request input field 230 may include information of a request. Content of the request input field 230 may be provided to a person who accepts a request. Content of the request input field 230 may include any type of information. For example, a pointer to audio, video, text, and/or other media may be indicated in the request input field 230. As illustrated in FIG. 2, the query ‘Who was Ronald Reagan?’ is the request input associated with ‘Request1’, as indicated in the request record 200a. In at least one embodiment, the request input field 230 may indicate an original user request, and a rewritten user request.

The request answer ID field 235 may include information of a search result associated with a request. Content of the request answer ID field 235 may be used to provide a search result. For example, a guide may cut a snippet of text from a web page in order to create a response to a request, or a responder may select a snippet or input an answer. An answer may include various types of media such as text, images, audio, html, etc. Content of the request answer ID field 235 may be produced automatically and/or using the assistance of a person. Using the example in FIG. 2, the answer ‘The Humane Society of Indianapolis offers free puppy training classes.’, ‘Bark Tutor in Indianapolis offers dog training classes.’, and ‘Petsmart offers certified training for your dog.’, are associated with the request record 200c. This may indicate that those answers may be returned responsive to ‘Request3’.

The request answer resource field 240 may include information of a resource associated with a request. Content of the request answer resource field 240 may be used for various purposes. As illustrated in FIG. 2, the URL <<indyhumane.org>> is indicated in the request record 200c. This may indicate that content indicated by that URL may have been used to obtain a response indicated in the request answer ID field 235. In an embodiment, the request answer ID field 235 and the request resource field 240 may be linked by for example a pointer. If a URL is associated with a commercial entity, a rating or ranking of an answer may be affected, and may influence a probability that an answer will be presented responsive to a request.

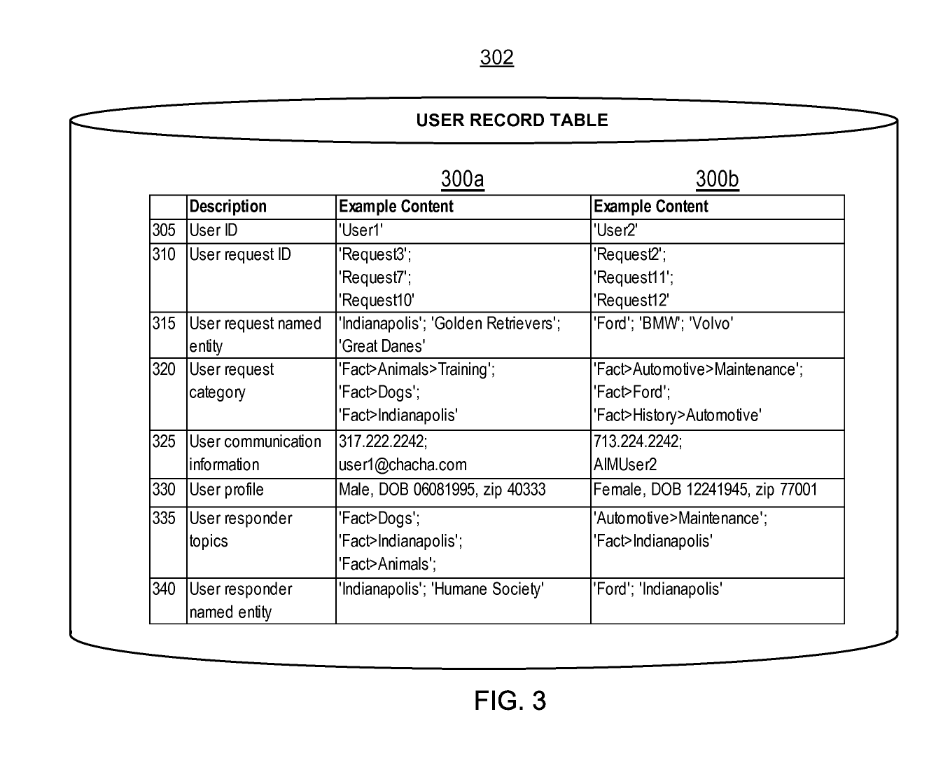

As illustrated in FIG. 3 an exemplary user record table 302, which may comprise a number of user records is provided. One or more user records may be associated with or resident in the database 120 (FIG. 1). The user record table 302 may include information of users. The user records 300a, b may include a user ID field 305, a user request ID field 310, a user request named entity field 315, a user request category field 320, a user communication information field 325, a user profile field 330, a user responder topics field 335, and a user responder named entity field 340.

The user ID field 305 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 305. Using the example in FIG. 3, ‘User1’ is the user ID associated with the user record 300a.

The user request ID field 310 may include information of a number of requests associated with a user. A user request ID may be for example a pointer to a request record associated with a request submitted by a user. If a user submits a request, a request ID may be added to the user request ID field 310. Using the example illustrated in FIG. 3, ‘Request2’, ‘Request11’ and ‘Request12’ are associated with ‘User2’ as indicated in the user record 300b. This may indicate that ‘User2’ has submitted ‘Request2’, ‘Request11’ and ‘Request12’.

The user request named entity field 315 may include information regarding a number of named entities indicated by user requests. If a user request indicates a named entity a tag associated with a named entity may be suggested to a user as a responder topic. For example ‘Indianapolis’; ‘Golden Retrievers’; and ‘Great Danes’ may be named entities associated with requests submitted by ‘User1’ as indicated in the user record 300a.

The user request category field 320 may include information regarding a category or type associated with a user request. For example, if a request is directed to a type of processing or a category, etc. a type and/or category associated with the processing may be indicated in the user request category field 320. In at least one embodiment, the user request ID field 310 and the user request category field 320 are linked by for example a pointer. An affiliation of a user may affect a category associated with a request of a user. A category may be assigned to a request automatically and/or using a human assistant.

The user communication information field 325 may include information of a number of communication services associated with a user. Any information which may be used to establish communication with a user may be indicated in the user communication information field 325. For example, a telephone number, an email address, an IM credential, a URL, a username, a password, and/or other communication information may be indicated in the user communication information field 325. Using the example in FIG. 3, the phone number ‘317.222.2242’ and the email ‘user1@chacha.com’ are associated with ‘User1’.

The user profile field 330 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 3, ‘Female, DOB 12241945, zip 77001’ are associated with ‘User2’. Profile information may be used to match information provided by a user to other information. For example, a ranking of a guide for a query of a user may be adjusted based on a profile associated with the user. A category and/or named entity might be modified based on geographic, demographic, etc. profile information of a user. For example, if a user is located close to the city of Indianapolis, Iowa, that named entity might be preferred whereas the named entity Indianapolis, Ind. might be generally preferred.

The user responder topics field 335 may include information concerning topics and/or categories for which a user has agreed to accept requests. A user may select topics of interest, topics of knowledge, may select a topic for any reason as a topic of interest. A user may receive queries pertaining to topics indicated in the user responder topics field 335. For example, ‘User2’ may receive queries pertaining to ‘Automotive>Maintenance’ and ‘Fact>Indianapolis’ as illustrated in the user record 300b. A user may be able to sign up for a category and/or topic based on a ranking of a category, keyword, topic and/or named entity for a user. A topic may be a category and/or a tag associated with one or more named entities.

The user responder named entity field 340 may include information concerning a number of named entities for which a user will respond to requests. Named entities indicated in user requests may be used to determine named entities, topics, keywords, categories, etc. which may be suggested to users for accepting and responding to requests. For example, if a response to a user request indicates a named entity a number of times, a named entity and/or a keyword, topic, category, etc. associated with a named entity may be offered as a topic for which a user may act as a responder. As illustrated in FIG. 2, the named entity ‘Indianapolis’ is associated with ‘User1’ as indicated in the user responder named entity field 340. This may indicate that ‘User1’ may receive a request associated with the named entity ‘Indianapolis’.

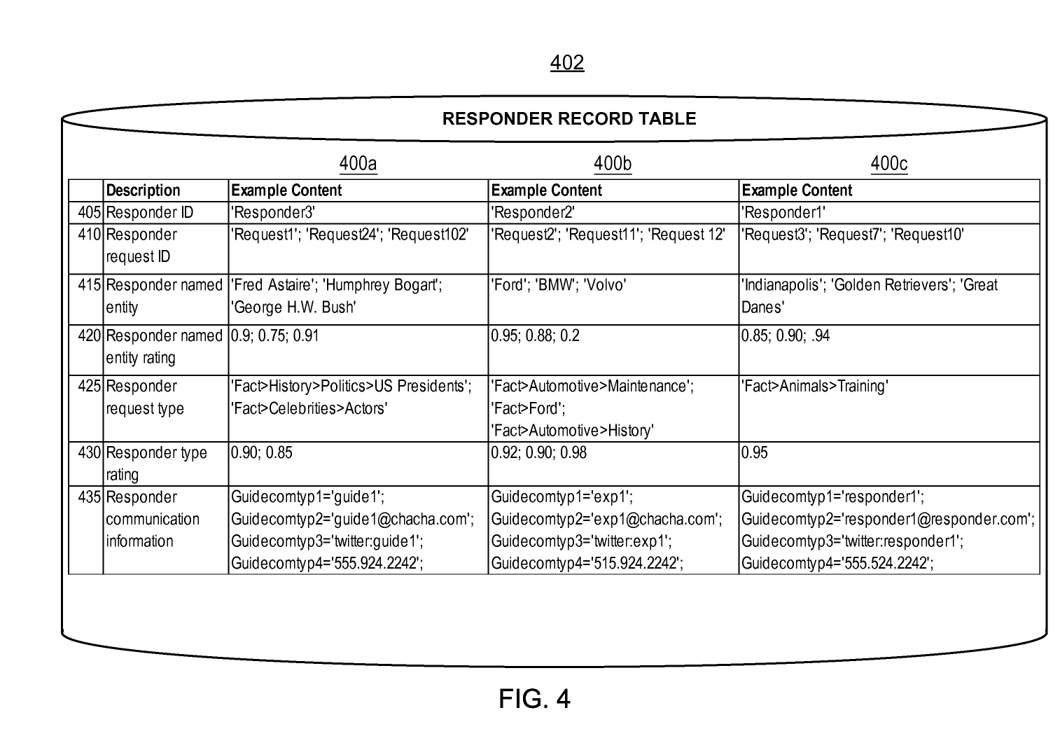

As illustrated in FIG. 4 an exemplary responder record table 402 which may comprise a number of responder records is provided. One or more responder records may be associated with or resident in the database 120 (FIG. 1). The responder record table 402 (FIG. 4) may include information of responders. The responder records 400 may include a responder ID field 405, a responder request ID field 410, a responder named entity field 415, a responder named entity rating field 420, a responder request type field 425, a responder type rating field 430 and a responder communication information field 435.

The responder ID field 405 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 405. The responder ID field 405 may indicate a user ID. In at least one embodiment, a pseudonym selected by a guide may be indicated in the responder ID field 405. Using the example in FIG. 4, ‘Responder1’ is the responder ID associated with the responder record 400c.

The responder request ID field 410 may include information of a number of requests associated with a responder. Content of the responder request ID field 410 may be used to obtain information of a request. For example, if a request has been determined to require a number of requests to be performed, the search system 130 (FIG. 1) may assign a unique ID to the requests and may distribute information of the requests to responders. Using the example in FIG. 4, ‘Request1’, ‘Request24’, and ‘Request102’ are associated with ‘Responder3’ as indicated in the responder record 400a. This may indicate that ‘Responder3’ has expedited or handled ‘Request1’, ‘Request24’ and ‘Request102’.

The responder named entity field 415 may include information of a number of named entities for which a responder has elected to receive queries. A responder may choose any number of named entities of interest for which a responder may receive requests. For example ‘Responder1’ may answer queries indicating the named entities ‘Indianapolis’; ‘Golden Retrievers’; and ‘Great Danes’ as indicated in the responder named entity field 415 of the responder record 400c. ‘Responder1’ may have answered queries regarding the named entities, may have expressed interested in the named entities, may have accepted a suggestion to register to respond to requests regarding the named entities, etc.

The responder named entity rating field 420 may include information of a number of ratings associated with a responder which ratings may be associated with named entities. For example, quality, speed, peer review, etc., may be used to determine a rating of a responder. A rating of a responder may be used for purposes such as determining compensation for the responder (e.g. recognition), selecting a responder to respond to a request, matching a request to a responder, etc. In at least one embodiment, the responder named entity field 415 and the responder named entity rating field 420 may be linked by, for example, a pointer. Using the example in FIG. 4, ‘Responder2’ has a rating of ‘0.95’ associated with the named entity ‘Ford’, a rating of ‘0.88’ associated with the named entity ‘BMW’; and a rating of ‘0.2’ associated with the named entity ‘Volvo’. These ratings may be used to rank ‘Responder2’ versus other responders associated with those named entities and/or topics, keywords, etc., associated with a named entity.

The responder request type field 425 may include information of a number of types of requests which may be processed by a responder. For example, a category and/or keyword associated with a request, a type of request, temporal information associated with a request, etc., which may be used to determine if a responder is to be presented with a request may be indicated in the responder request type field 425. In at least one embodiment, a responder may be assigned to a particular type of request as part of a registration process. A responder may select a type of request which a responder may perform. A responder may be required to pass a test in order to be associated with a type of request. A responder may be assigned to a role such as expediter, searcher, etc., which may be indicated in the responder request type field 425. A request indicating a category may be directed to a responder. Using the example in FIG. 4, ‘Responder1’ is associated with the category ‘Fact>Animals>Training.’ This may for example indicate that ‘Responder1’ may be presented with and/or selected to respond to requests indicating that category.

The responder type rating field 430 may include information concerning a rating of a responder. For example, a responders rating for a category and/or type of query may be indicated in the responder type rating field 430. A rating of a responder may be used to select a responder when a query is associated with a category and/or type. For example, a responder with a higher rating for a category may be more likely to be chosen for a task associated with a category than a responder with a lower rating.

The responder communication information field 435 may include information of a number of communication services associated with a responder. For example, a user name and password, an email address, an IM credential, a phone number, a web page, a physical address, etc., may be indicated in the responder communication information field 435. Using the example illustrated in FIG. 4, ‘Responder3’ is associated with the login ID ‘guide1’, the email ‘guide1@chacha.com’, the Twitter account ‘twitter.guide1’, and the phone number ‘555.924.2242’. This may indicated that ‘Responder3’ may be contacted using the associated communication services.

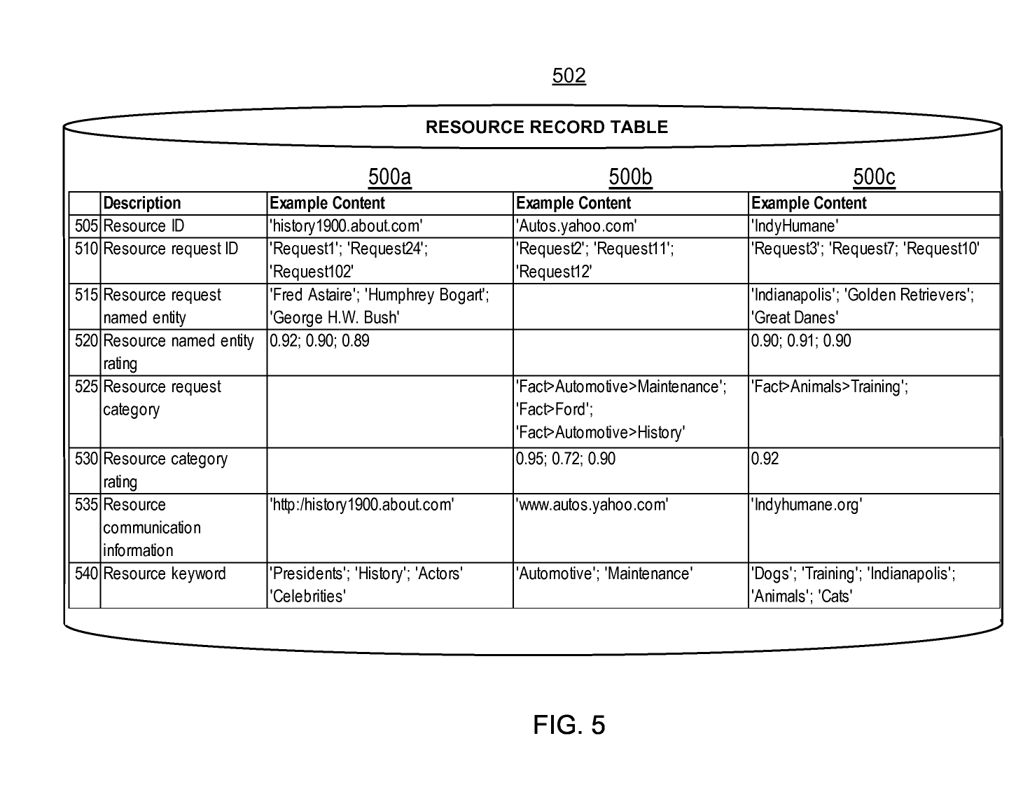

As illustrated in FIG. 5 an exemplary resource record table 502 which may comprise a number of resource records is provided. One or more resource records may be associated with or resident in the database 120 (FIG. 1). The resource record table 502 (FIG. 5) may include information of resources. The resource records 500 may include a resource ID field 505, a resource request ID field 510, a resource request named entity field 515, a resource named entity rating field 520, a resource request category field 525, a resource category rating 530, a resource communication information field 535 and a resource keyword field 540.

The resource ID field 505 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 5, ‘IndyHumane’ is the resource ID associated with the resource record 500c. This may indicate that ‘IndyHumane’ has been used to produce a search result, and is accessible to a guide and/or responder.

The resource request ID field 510 may include information of a number of requests associated with a resource. Content of the resource request ID field 510 may be used to obtain information of a request. For example, if a resource has been used to respond to a request, an identifier of the request may be indicated in the resource request ID field 510. Using the example in FIG. 5, ‘Request2’, ‘Request11’ and ‘Request12’ are associated with the resource ‘Autos.yahoo.com’ as indicated in the resource record 500b. This may indicate that ‘Autos.yahoo.com’ has been utilized to respond to ‘Request2’, ‘Request11’ and ‘Request12’.

The resource request named entity field 515 may include information of named entities indicated in requests for which a resource has been used to produce a response or answer. For example ‘Fred Astaire’; ‘Humphrey Bogart’ and ‘George H. W. Bush’ are associated with the resource ‘history1900.about.com’ as indicated in resource record 500a. This may indicate that ‘history1900.about.com’ has been used to respond to requests indicating those named entities.

The resource named entity rating field 520 may include information concerning a rating of a resource associated with a named entity. A rating of a resource for a named entity may be used to select a resource when a query is associated with a named entity. For example, a resource with a higher rating may be chosen over a resource with a lower rating pertaining to a named entity indicated in a query. Similarly, a high rating of a resource for a named entity may affect a rating of the resource for a topic associated with other named entities. For example, a high rating for the named entity ‘George H. W. Bush’ might increase a rating and/or ranking of a resource for a query indicating a named entity associated with the topics ‘Presidents’, ‘Famous Persons’, etc.

The resource request category field 525 may include information of a number of categories of requests which may be processed by a resource. For example, a category and/or keyword associated with a request, a type of request, profile, etc., which may be used to determine if a resource is to be presented to a guide or responder or user for a request may be indicated in the resource request category field 525. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 5, ‘Fact>Automotive>Maintenance’; ‘Fact>Ford’ and ‘Fact>Automotive>History’ are associated with the resource ID ‘Autos.yahoo.com’ as indicated by the resource record 500b.

The resource category rating field 530 may include information of a number of ratings associated with a resource and a category or type. For example, a rating of a resource may be based on ratings of answers produced using the resource, a contractual agreement, an affiliation, temporal information such as time spent by guides, etc. A rating of a resource for a category or type may be used to select a resource which is provided to a responder or guide, to rank a response associated with a resource, etc. In at least one embodiment, the resource request category field 525 and the resource category rating field 530 may be linked by, for example, a pointer. Using the example in FIG. 5, ‘IndyHumane’ has a rating of ‘0.92’ associated with ‘Fact>Animals>Training’ which may indicate that ‘IndyHumane’ may be more likely to produce an acceptable response for that category than a resource such as “barktutor.com” providing the answer ‘Bark Tutor in Indianapolis offers dog training classes’ which may be rated lower due to being a commercial site. A resource may have a rating corresponding to various categories, types of information, types of tasks, keywords, etc.

The resource communication information field 535 may include information of a number of communication services associated with a resource. For example, a user name and password, an email address, an IM credential, a phone number, a web page, a physical address, etc., may be indicated in the resource communication information field 535. A communication service indicated in the resource communication information field 535 may for example be used to indicate a service by which a resource may be accessed. Using the example illustrated in FIG. 5, the URL <<‘http:/history1900.about.com’>> is associated with ‘history1900.about.com’. This may indicate that content of the resource may be retrieved using that URL.

The resource keyword field 540 may include information of a number of keywords associated with a resource. A match to a keyword indicated in the resource keyword field 540 may affect a probability that a request will receive a response associated with a resource. For example, a match may prohibit a query from receiving a result from a resource, may increase a ranking of a resource, may be used to associate a category with a request, may identify a resource to be provided to a guide, etc. In at least one embodiment, keywords included in requests for which a resource has provided an answer may be more highly ranked for a category associated with the query and the resource. A sponsor may select keywords associated with a resource provided by the sponsor. A URL associated with a sponsored resource may be compared to a URL of a result.

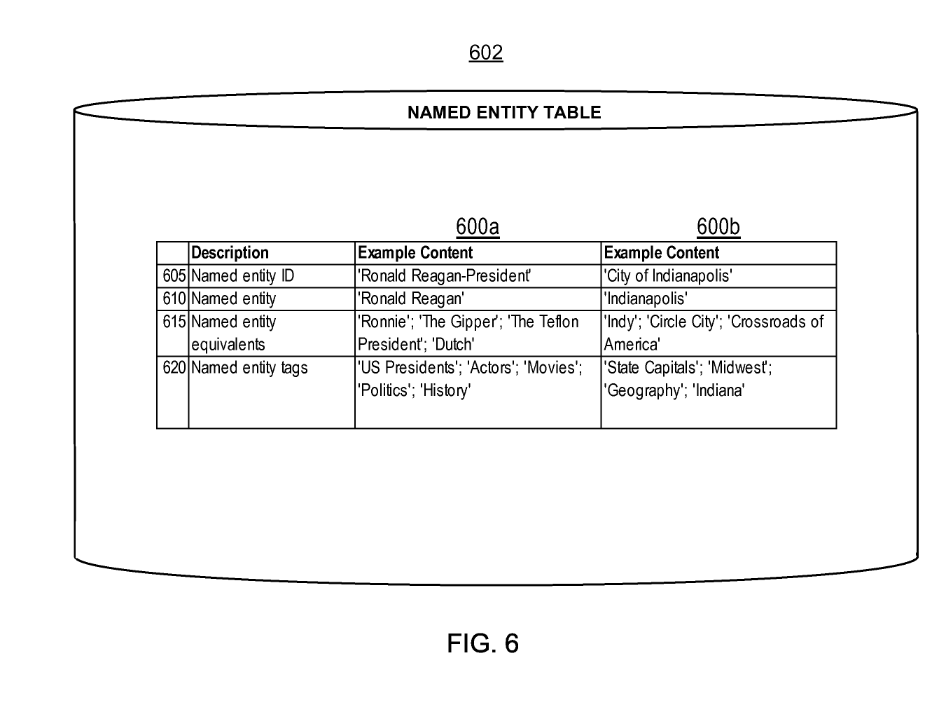

As illustrated in FIG. 6 an exemplary named entity table 602 which may comprise a number of named entity records is provided. One or more named entity records may be associated with or resident in the database 120 (FIG. 1). The named entity table 602 may include information of named entities. The named entity records 600 may include a named entity ID field 605, a named entity field 610, a named entity equivalents field 615 and a named entity tags field 620.

The named entity field ID 605 includes an identifier of a named entity which is preferably unique and is preferably used consistently. A named entity ID serves to distinguish a named entity record associated with a named entity from a named entity record associated with other named entities. Any number of characters, numbers, and/or other indicators may be used to indicate a named entity ID. Using the example in FIG. 6, ‘Ronald Reagan-President’ is the named entity ID associated with the named entity record 600a. A named entity ID may indicate a differentiation of a named entity from other named entities which may be similar or identical. For example, ‘Ronald Reagan-President’ might distinguish from a highway, airport, etc. with the same name. A named entity ID may be presented to a person when a query is associated with a named entity.

The named entity field 610 includes information which may be used to determine whether a named entity is indicated in a query. A named entity may be any specifically named person, place, and/or thing. For example the city ‘Indianapolis’ is a named entity in the named entity record 600b. This might be distinguished from the USS Indianapolis, or Indianapolis, Iowa.

The named entity equivalents field 615 may include named entities which are equivalent to a named entity. A named entity may have nicknames, different spellings, and/or references and/or other noun phrases which might refer to a named entity. Noun phrases indicated in the named entity equivalents field 615 may be included when testing for a named entity. For example, ‘Ronnie’; ‘The Gipper’; ‘The Teflon President’; and ‘Dutch’ are all possible named entity equivalents to ‘Ronald Reagan’ the named entity found in the query ‘Who was Ronald Reagan?’ as illustrated in the request record 200a (FIG. 2).

The named entity tags field 620 includes information of a number of tags related to a named entity. Tags show possible groupings to which a named entity may belong. For example in FIG. 6 the named entity ‘Indianapolis’ may be tagged as ‘State Capitals’, ‘Indiana’, ‘Midwest’, and ‘Geography’ as illustrated in named entity record 600b. This may indicate that an items such as a responder, resource, guide, user, image, media, advertisement, search result, answer, named entity, keyword, etc. which is associated with a tag associated with a named entity may be selected for a request which indicates the named entity. For example, if a query is associated with ‘City of Indianapolis’ is submitted, if a responder associated with ‘Indianapolis’ is not available, responders associated with ‘Indiana’, ‘State Capitals’, and ‘Geography’ might selected to respond to a request. Similarly, if a resource has a high rating for ‘Indiana’ and there is no resource associated with ‘Indianapolis’, a resource associated with ‘Indiana’ might be selected to respond to a request indicating ‘City of Indianapolis’. A tag or topic may have a weighting associated with a named entity. For example, ‘Indiana’ might have a higher weight than ‘Midwest’ which might have a higher weight than ‘State Capitals’, which might have a higher weight than ‘Geography’. Thus an item associated with the higher weighted or more specific tags or topics may be more probable or likely to be selected.

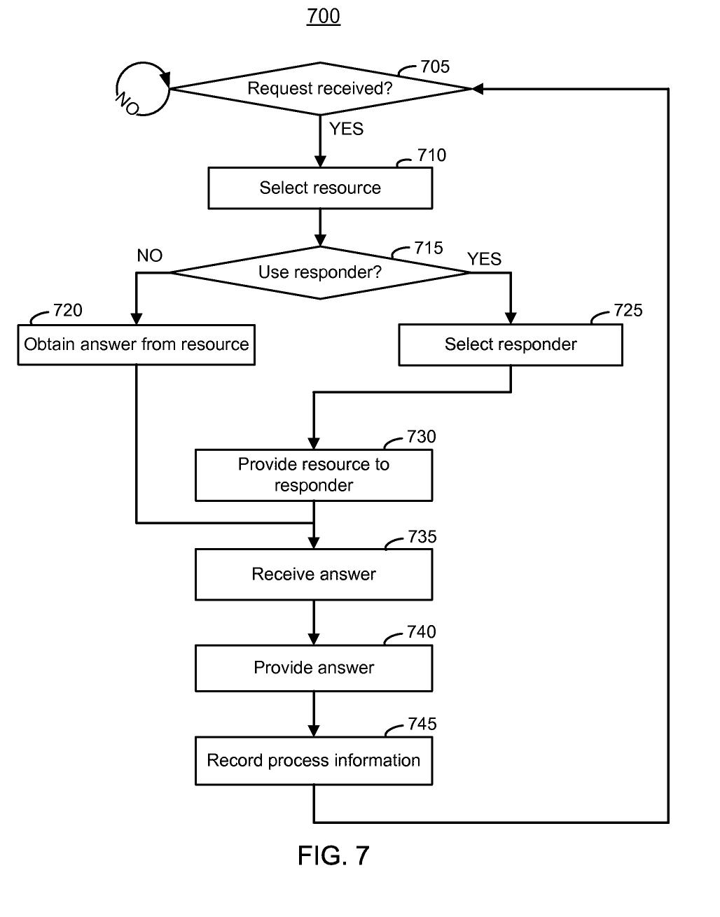

As illustrated in FIG. 7, a process 700 for providing an answer is provided. The process 700 may be performed in whole or in part by any suitable element of the system 100 (FIG. 1). In at least one embodiment, the process 700 is operative on a server associated with the search system 130 (FIG. 1). A request may be a request for an automated answer, a human assisted answer and/or a combination thereof.

In operation 705 (FIG. 7) a determination is made as to whether a request is received. If it is determined in operation 705 that a request is not received, control remains at operation 705 and process 700 continues. If it is determined in operation 705 that a request is received, control is passed to operation 710 and process 700 continues.

The determination in operation 705 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. If a message is received at a server associated with the search system 130, it may be determined that a request is received.

In operation 710 a resource is selected. A resource may be selected using various criteria. A resource may be selected because it contains information related to a category and or a named entity. A resource may be selected because it is ranked highly, has a high rating and/or may be more likely to be accurate than another resource. A resource may be selected based on a keyword, tag, named entity, etc., associated with for example the request. Control is passed to operation 715 and process 700 continues.

In operation 715 a determination is made as to whether a responder will be used. If it is determined in operation 715 that a responder will be used, control is passed to operation 725 and process 700 continues. If it is determined in operation 715 that a responder will not be used control is passed to operation 720 and process 700 continues.

The determination in operation 715 may be made using various criteria. In at least one embodiment, if a response to a request is already in the database 120 (FIG. 1), or if an automated response of a resource is deemed acceptable, it may be determined that a responder will not be used. For example, if a query has been previously presented and stored in the database an automated answer may be supplied to a user. If a resource such as an RSS feed or search engine produces an answer which is found to match a request it may be determined that a responder is not used. If a query originates from a particular source it may be determined that a responder is used. For example, if a request originates from a source which requires a high level of certainty that an answer is correct, it may be determined that a responder will be used. In an embodiment, it may be that determined that a response may be produced using a responder and that an automated response may be produced by a resource. For example, an advertisement might be selected using a resource, while an answer might be produced by a responder.

In operation 725 a responder is selected. A responder may be selected based on categories and/or named entities for which a responder may have signed up or been associated with. A responder may choose any number of categories and/or named entities. Category and/or named entity selections may be used to determine which responder may be best for responding to a query. A responder may also be chosen based on a responder rating for a named entity and/or a category. For example, a responder with a higher rating for a particular named entity may be selected over a responder with a lower rating for the same named entity. Control is passed to operation 730 and process 700 continues.

In operation 720 an answer is obtained from a resource. Information of a resource may be stored in the database 120 (FIG. 1) and may be used to provide an answer to a user. Stored information of a resource may include information regarding a category and/or named entity. A stored and/or automated answer may be used to provide a quicker response to a query. A resource may provide an answer while a responder is being selected and/or prior to presentation of a response of a responder or guide. An advertisement may be selected based on a response of a resource. Control is passed to operation 735 and process 700 continues.

In operation 730 a resource is provided to a responder. A resource may be provided to a responder based on various factors. A resource may be provided to a responder based on rating and/or ranking of a resource, content of a resource, etc. A resource may be selected based on a named entity and/or a category associated with a query and a resource. A resource may be selected based on a responder. For example, if a responder is known to prefer a type of resource, a ranking of a resource may be increased. Content obtained from a resource may be presented to a responder. Control is passed to operation 735 and process 700 continues.

In operation 735 an answer is received. An answer may be received from a resource and/or a responder. Multiple answers may be received and a responder may choose a best answer. A single answer may be provided to a responder and may be passed along to a user if a responder accepts the answer, does not reject the answer, indicates that an answer is superior, etc. Control is passed to operation 740 and process 700 continues.

In operation 740 an answer is provided. An answer may be provided in various ways. For example an answer may be presented via a device which submitted a request, an answer may be stored in the database 120 (FIG. 1), and/or an answer may be presented to a device determined by a user submitting a request. Control is passed to operation 745 and process 700 continues.

In operation 745, process information is recorded. Information of a request, an answer, a category, a keyword, a resource, a user, a sponsor, a guide, a responder, a rating, a ranking, etc. may be recorded. A stored response may be rated, ranked, or deleted. For example, if a stored response is rejected by a responder, a ranking of a response for a request, keyword, type, named entity, etc. may be modified. In at least one embodiment, process information is recorded in the database 120 (FIG. 1). Control is passed to operation 705 and process 700 continues.

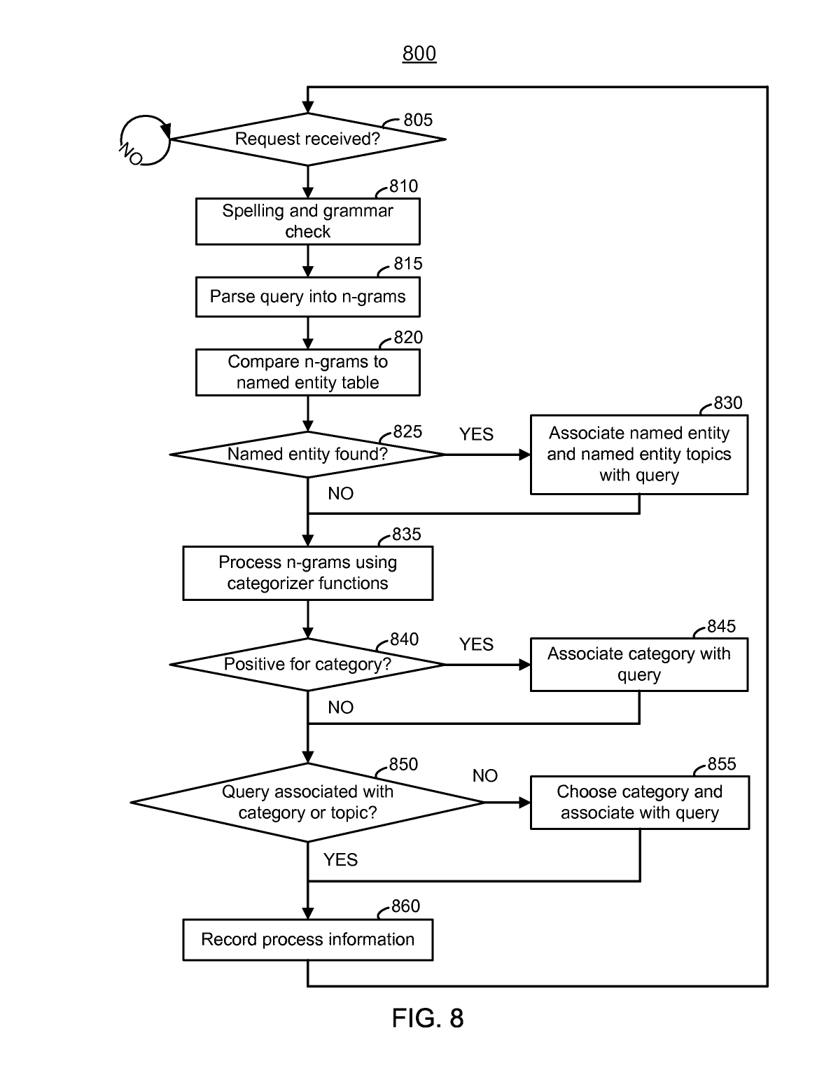

As illustrated in FIG. 8, a process 800 for associating a category and/or tag with an item is provided. The process 800 may be performed in whole or in part by any suitable element of the system 100 (FIG. 1). In at least one embodiment, the process 800 is operative on a server associated with the search system 130 (FIG. 1). A request may include text of a query and/or other media associated with a request.

In operation 805 (FIG. 8) a determination is made as to whether a request is received. If it is determined in operation 805 that a request is not received, control remains at operation 805 and process 800 continues. If it is determined in operation 805 that a request is received, control is passed to operation 810 and process 800 continues.

The determination in operation 805 may be made using various criteria. In at least one embodiment, if a message is received at a system associated with the search system 130 (FIG. 1), it may be determined that a request is received. For example, if an email message, an SMS, EMS, and/or MMS message, an IM, an IP message, and/or a voice message is received at an address associated with the search system 130, it may be determined that a request is received. If a message is received at a server associated with the search system 130, it may be determined that a request is received.

In operation 810 spelling and grammar are checked. Spelling and grammar may be checked to ensure an accurate category and/or recognition of a named entity is obtained and an accurate response is provided. Spelling and grammar may be checked by an algorithm equivalent to spell check in a commercial word processor. Content of a request may be compared to a gazette of named entities and aliases such as that illustrated in FIG. 6. Grammar checking may include creation of a Penn Tree or other grammatical analysis techniques. Control is passed to operation 815 and process 800 continues.

In operation 815 a query is parsed into n-grams. Parsing a query into n-grams may be used to create a language model for predicting the next item in a sequence. Parsing into n-grams may also allow for greater natural language processing, such as parts of speech tagging. Control is passed to operation 820 and process 800 continues.

In operation 820 n-grams are compared to a named entity table. N-grams are compared to a named entity table to determine a probability that a query may be referring to a named entity. A match of an n-gram to a named entity may indicate a query is referring to a named entity. Not detecting a match may not indicate a query does not refer to a named entity. A match to a longer n-gram may be favored as it may indicate a more specific named entity. Control is passed to operation 825 and process 800 continues.

In operation 825 (FIG. 8) a determination is made as to whether a named entity is found. If it is determined in operation 825 that a named entity is found, control passed to operation 830 and process 800 continues. If it is determined in operation 825 that a named entity is not found, control is passed to operation 835 and process 800 continues.

The determination in operation 825 may be made on various criteria. In an embodiment a named entity may be considered found when a named entity in the database 120 (FIG. 1) matches a named entity in a query. A named entity may not be found when a misspelling takes place, or if a number of changes required to match a named entity is exceeded. A named entity may be recognized based on an action by a responder. For example, a responder may be presented with information which would be relevant if a named entity is correctly recognized and if a responder indicates the information is correct, it may be determined that a named entity is found. If a named entity is composed of a subset of tokens included in another named entity and the other named entity is found, it may be determined that a named entity is not found. Any number of named entities might be found.

In operation 830 named entities and named entity topics are associated with a query. Named entities and named entity topics may be associated with a query as guidance to a responder in choosing a resource and/or response. For example, the named entity ‘Ronald Reagan’ may be associated with the topics ‘U.S Presidents’, ‘Actors’ and ‘Politics’. Tags or topics associated with a named entity may be used to select any item and/or person. Control is passed to operation 835 and process 800 continues.

In operation 835 n-grams are processed using categorizer functions. A categorizer function may be a Bayesian filter which is trained based on a group of queries which have been previously classified. A categorizer may be a filter which is designed to detect queries which include particular words and/or exclude others. A categorizer may assign a probability that a query is associated with a category. In general a categorizer is broadly targeted so as to have a high probability of associating a category with a request. Control is passed to operation 840 and process 800 continues.

In operation 840 a determination is made as to whether a positive for a category is detected. If it is determined in operation 840 that a positive for a category is detected, control passed to operation 845 and process 800 continues. If it is determined in operation 840 that a positive for a category is not detected, control is passed to operation 850 and process 800 continues.

The determination in operation 840 may be made based on various criteria. A threshold may be applied to a probability assigned by a categorization filter, which may determine that a request is associated with a category. If a query is associated with multiple categories, it may be determined that only a highest ranking category is associated with a query. If a query is determined to be associated with a category, other categories may be excluded. Any suitable criteria may be used to determine whether a positive for a category is detected.

In operation 845 a category is associated with a query. A category may be associated with a query if it has a highest probability for a query. In an embodiment, a query may be associated with only one category. In an embodiment, any category which indicates a probability above a threshold may be associated with a query. Control is passed to operation 850 and process 800 continues.

In operation 850 a determination is made as to whether a query is associated with a category or topic. If it is determined in operation 850 that a query is associated with a category or topic, control passed to operation 860 and process 800 continues. If it is determined in operation 850 that a query is not associated with a category or topic, control is passed to operation 855 and process 800 continues.

The determination in operation 850 may be made based on various criteria. If a query has been associated with a named entity, it may be determined that a query is associated with a category or topic. If a query is associated with at least one category it may be determined that a query is associated with a category or topic. Any suitable criteria may be used to determine whether a query is associated with a category or topic.

In operation 855 a category is chosen and associated with a query. Categorization filters may favor false negatives (i.e., are more likely to indicate a category of a query is not suitable). As such, if a query is not associated with a category and/or topic a most likely category may be assigned to a query based on being a least probably incorrect category. For example, a lower acceptance threshold might be applied to the categorization filters, or a composite of categorizations might be used to determine a highest non-positive category. A default general category may be assigned to a request if a category filter has not identified a category. A responder or human assistant may be used to assign a category to a request. Control is passed to operation 860 and process 800 continues.

In operation 860, process information is recorded. Information of a request, a category, a keyword, a resource, a user, a sponsor, a guide, a responder, a rating, a ranking, etc. may be recorded. A categorization filter may be modified. For example, if a named entity is known to be associated with a particular category, a query including the named entity might be used for feedback to a classifier or categorization filter. Similarly, if a responder has indicated that a classification filter is in error, or that a named entity detection is incorrect, information of the error and correction may be stored. In at least one embodiment, process information is recorded in the database 120 (FIG. 1). Control is passed to operation 805 and process 800 continues.

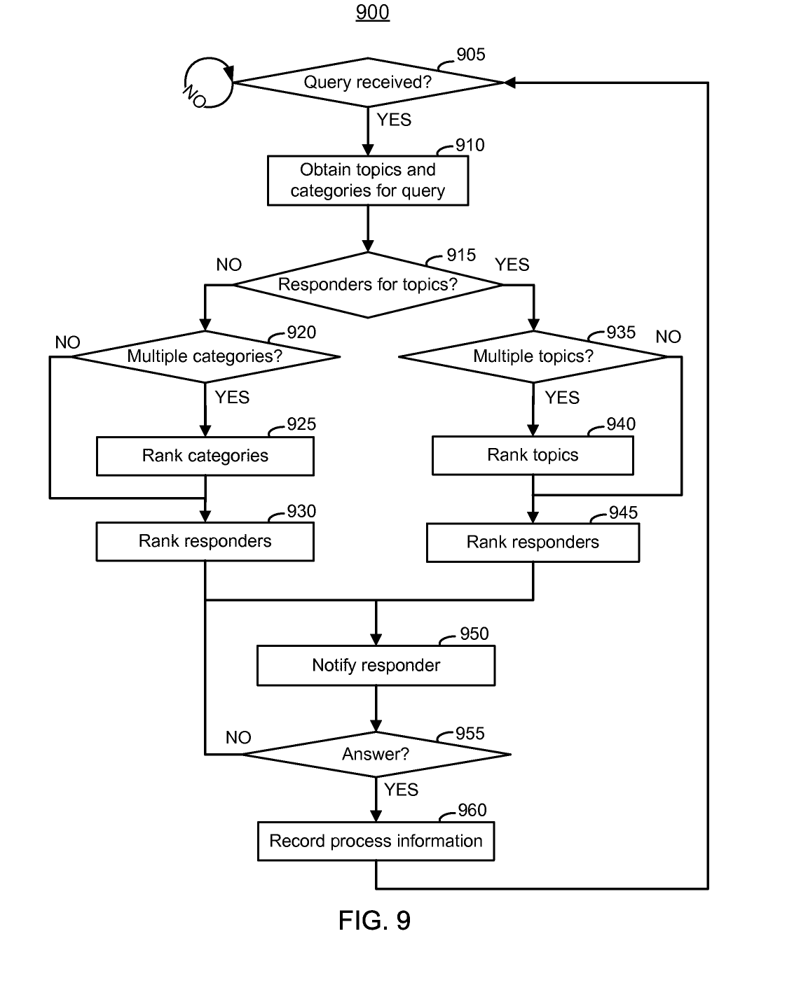

As illustrated in FIG. 9, a process 900 for selecting an item is provided. The process 900 may be performed in whole or in part by any suitable element of the system 100 (FIG. 1). In at least one embodiment, the process 900 is operative on a server associated with the search system 130 (FIG. 1). A query may include text of a request and/or other media associated with a query. A query may request any item based on any media indicated in a query.

In operation 905 (FIG. 9) a determination is made as to whether a query is received. If it is determined in operation 905 that a query is not received, control remains at operation 905 and process 900 continues. If it is determined in operation 905 that a query is received, control is passed to operation 910 and process 900 continues.

The determination in operation 905 may be made using various criteria. In at least one embodiment, if a message is received at a system associated with the search system 130 (FIG. 1), it may be determined that a query is received. For example, if an email message, an SMS, EMS, and/or MMS message, an IM, an IP message, and/or a voice message is received at an address associated with the search system 130, it may be determined that a query is received. If a message is received at a server associated with the search system 130, it may be determined that a query is received.

In operation 910 topics and categories for a query are obtained. Topics and categories for a query may be obtained using a process such as the process 800 (FIG. 8), may be obtained from stored information, maybe provided by a source of a query, etc. Control is passed to operation 915 and process 900 continues.

In operation 915 a determination is made as to whether a responder is associated with a topic. If it is determined in operation 915 that a responder a responder is associated with a topic, control is passed to operation 935 and process 900 continues. If it is determined in operation 915 that a responder a responder is not associated with a topic control is passed to operation 920 and process 900 continues.

The determination in operation 915 may be made using various criteria. If a responder has registered to receive requests associated with a topic, it may be determined that there is a responder for a topic. If a responder has registered to receive requests associated with a named entity associated with a topic, it may be determined that there is a responder for a topic. If a responder has indicated that a named entity or topic is blocked, it may be determined that there is not a responder for a topic. Any suitable criteria may be used to determine whether there is a responder for a topic.

In operation 920 a determination is made as to whether a query is associated with multiple categories. If it is determined in operation 920 that a query is associated with multiple categories, control is passed to operation 925 and process 900 continues. If it is determined in operation 920 that a query is not is associated with multiple categories control is passed to operation 930 and process 900 continues.

The determination in operation 920 may be made using various criteria. For example, a query such as ‘Who is Ronald Reagan?’ may be associated with the categories ‘US Presidents’ and ‘Actors’. If a plurality of category filters provide a match to a query, it may be determined that a query is associated with multiple categories. In an embodiment only one category may be associated with a query.

In operation 925 categories are ranked. A category may be ranked based on which category a query is more likely referring to. For example a query may contain multiple categories, but one category may be more likely to be the category to which a query refers based on a probability associated with a category detector. A category may be ranked based on specificity of a category, a number of responders registered for a category, query frequency associated with a category, etc. A ranking of a category may be based on a combination of criteria. Availability of responders associated with a category may affect a ranking of a category. Control is passed to operation 930 and process 900 continues.

In operation 930 responders are ranked. A responder may be ranked based on a category for which a responder has signed up for and/or a category for which a responder may be highly rated. A rating of a responder for a category may be based on factors such as response time, user ratings, peer ratings, a time interval since an activity, a frequency of activity, etc. Responder ranking may allow a query to be answered more accurately and more quickly. Control is passed to operation 950 and process 900 continues.

In operation 935 a determination is made as to whether a query is associated with multiple topics. If it is determined in operation 935 that a query is associated with multiple topics, control is passed to operation 940 and process 900 continues. If it is determined in operation 935 that a query is not associated with multiple topics control is passed to operation 945 and process 900 continues.

The determination in operation 935 may be made using various criteria. A query may contain multiple topics. For example, ‘Where can I train my Rottweiler in Indianapolis?’ includes the named entities Rottweiler and ‘Indianapolis’, which may be associated with the topics ‘Dogs’, ‘Pets’, ‘Animals’ and ‘Indiana’, ‘Midwest’, ‘State Capitals’ and ‘Geography’.

In operation 940 topics are ranked. A topic may be ranked based on specificity of a topic as determined by a weight assigned to a topic and a named entity. A topic may be ranked based on a number of responders available to accept requests associated with a topic. A topic may be ranked based on a ranking of a named entity associated with a topic. For example, if fewer topics are associated with a named entity a topic associated with the named entity may have a lower or higher ranking. If a plurality of named entities of a query is associated with a topic a rank of the topic may be adjusted. Any combination of criteria may be used to rank a topic. Control is passed to operation 945 and process 900 continues.

In operation 945 responders are ranked. A responder may be ranked based on topics for which a responder has signed up for and/or topics for which a responder may be highly rated. A ranking of a responder may be based on availability of a responder, response time associated with a request, a sponsor or advertiser associated with a topic or a responder, etc. A rank of a responder may be made based on any or all topics associated with a query or request. A rank of a responder may be based on requests submitted by a responder. Control is passed to operation 950 and process 900 continues.

In operation 950 responders are notified. A responder may be notified by any communication service associated with a responder. A responder may be notified of a query by a notification in an application operative on a device such as the user device 105 (FIG. 1) or the guide device 135. A responder may be selected and/or notified in an order based on a ranking of a responder for a category, a topic, a named entity, etc. Any number of responders may be notified of a request. If a responder has been previously notified, a ranking of a responder for a request may be reduced and/or set to a lowest ranking. Control is passed to operation 955 and process 900 continues.

In operation 955 a determination is made as to whether an answer is provided. If it is determined in operation 955 that an answer is provided control is passed to operation 960 and process 900 continues. If it is determined in operation 955 that an answer is not provided control is passed to operation 950 and process 900 continues.

The determination in operation 955 may be made using various criteria. A determination that an answer has been received may be made based on time taken to submit a response. If a responder takes more than a predetermined time in providing a response it may be determined that an answer is not received. If a responder provides an answer which a user indicates is accepted it may be determined that an answer is received. An action of a responder such as activation of a control in a user interface may be used to determine whether an answer is provided. If a number of answers are received it may be determined that an answer is received. Any suitable criteria may be used to determine that an answer is received. If an answer is provided to a source of a request, it may be determined that an answer is received. Control is passed to operation 960 and process 900 continues.

In operation 960, process information is recorded. Information of a request, an answer, a category, a keyword, a resource, a user, a sponsor, a guide, a responder, a rating, a ranking, etc. may be recorded. A response may be rated, ranked, or deleted. For example, if a response is rejected by a user, a ranking of a request, keyword, type, named entity, etc. may be modified. In at least one embodiment, process information is recorded in the database 120 (FIG. 1). Control is passed to operation 905 and process 900 continues.

While selection of a responder is used for the purpose of illustration in describing the process 900, no limitation is implied thereby. The process 900 may be used to select and/or rank any type of items for a query or request or search. For example, an advertisement, an image, a resource, a search result, a query, a user, a profile, and/or any other item might be selected based on a ranking of an item associated with a category and/or a topic associated with a request.

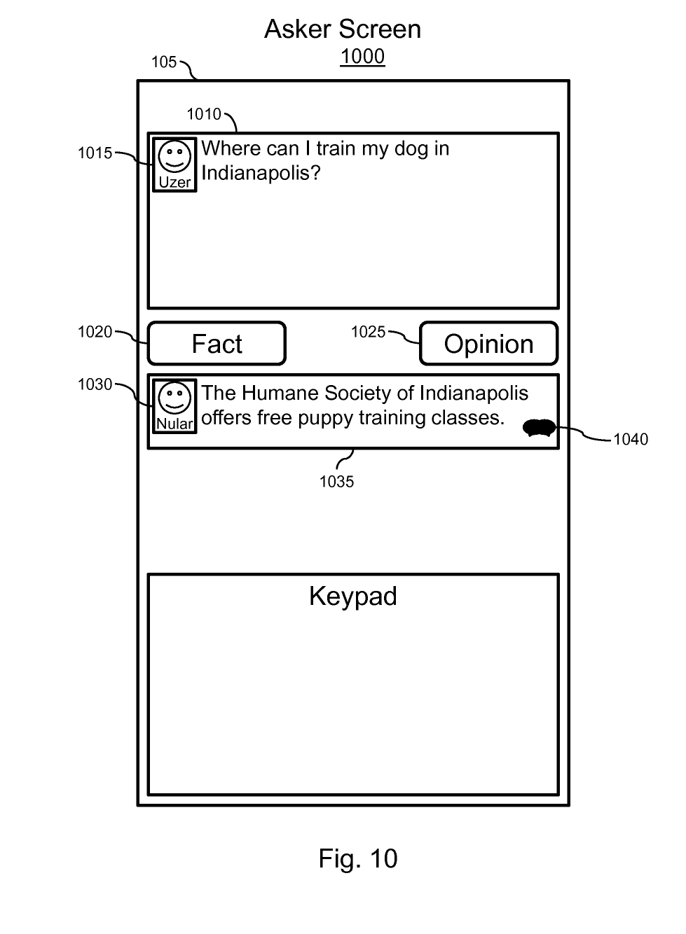

As illustrated in FIG. 10 an exemplary query submission GUI 1000 is provided. The GUI 1000 may be provided to a user. The GUI 1000 may be presented using a system such as the user system 105 (FIG. 1). The GUI 1000 may be used submit any type of request. The GUI 1000 may include a query indicator area 1010, a user identifier 1015, a factual query indicator 1020, an opinion query indicator 1025, a responder indicator 1030, a response indicator 1035, a conversation indicator 1040 and user controls 1045.

As illustrated in FIG. 10, the query indicator area 1010 may be used to indicate a query. For example a user may submit a query by entering information in the query indicator area 1010. The user identifier 1015 may indicate user submitting a request. Selection of the factual query indicator 1020 may cause a request indicated in the query indicator area 1010 to be processed as a factual query. Selection of the opinion query indicator 1025 may cause a request indicated in the query indicator area 1010 to be processed as request for subjective information. The responder indicator 1030 may indicate a source of a response. As illustrated in FIG. 10, ‘Nular’ which may be a person has responded with an answer indicated in the response indicator 1035. The conversation indicator 1040 may be used to establish a two-way exchange with a responder indicated by the responder indicator 1030. If a responder has declined to receive two-way communications, is an automated system, or for any reason the conversation indicator 1040 may be inactive as indicated by for example the filled indicator in FIG. 10. Any suitable indicator such as color, shading, etc. may be used to indicate that the conversation indicator 1040 is active or inactive. The user controls 1045 may be used to provide information of a query. While a keypad is used for purposes of illustration in FIG. 10 any type of input controls which are well known in the art may be used to provide information of a request, which may include images, video, audio, URL's, etc.

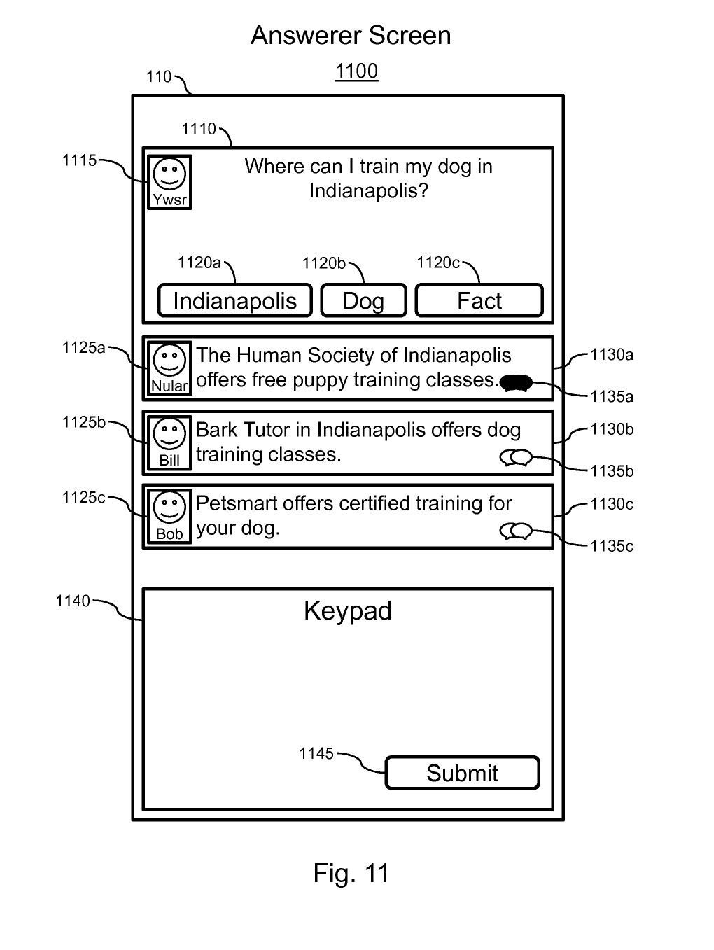

An exemplary GUI 1100 for responding to a request or question is illustrated in FIG. 11. The GUI 1100 may be presented on a device such as the user system 110 (FIG. 1) or the guide system 140. The GUI 1100 may include a query indicator 1110, a user indicator 1115, topic indicators 1120a-1120c, responder indicators 1125a-1125c, response indicators 1130a-1130c, responder conversation indicators 1135a-1135c, input controls 1140 and action control 1145.

The query indicator 1110 may be used to indicate a query to which responses are to be provided. The user indicator 1115 may be used to provide information of a user associated with a request indicated in the query indicator 1110. The topic indicators 1120a-1120c may be used to indicate information which may be used to select a query and/or a responder. For example, a category, keyword, topic, classification, etc. associated with a request may be indicated in the category indicators 1120a-1120c. For example, the category indicator 1120c may be used to select ‘Fact’ type queries. The responder indicators 1125a-1125c may be used to indicate information of a responder associated with a response. For example, the responder indicator 1125b may indicate that ‘Bill’ has provided the answer ‘Bark Tutor in Indianapolis offers dog training classes.’ The conversation indicators 1135a-1135c may indicate whether a responder is accepting responses. For example, activation of the conversation indicator 1135c might establish a two-way communication with the responder ‘Bob’. The input controls 1140 may be used to enter a response to a request indicated in the query indicator 1110. The ‘Submit’ action control 1145 may be used to submit a response to a request.

Using the methods and systems described herein a query is associated with a category and/or topic. A query is parsed to identify potential named entities or noun phrases indicated in a query. A named entity may be used to assign tags or topics to a query. Topics may be assigned a weighting based on specificity. An item such as a responder, resource, image, media, etc. may be associated with a query based on a relationship between named entity of a request and a named entity associated with an item. A preference may be given to a named entity based on specificity. A topic may be assigned to a named entity based on a topic table which is shared between named entities. A named entity may be a most granular topic as items may be specific to a named entity. If a query is associated with a named entity and no item is associated with the named entity, an item associated with a topic of the named entity may be selected.

Topics associated with a named entity may be used to relate items assigned to named entities. For example, if a named entity is associated with a topic, and a small number of items are associated with the topic a query associated with the named entity may be more likely to select an item associated with the topic than a topic which is associated with a larger number of named entities. Named entities may be obtained based on indexing of media. Named entities found in related media may be more likely to be associated with a common topic.

A category may be assigned to a request. A request may be assigned to a category if a named entity is not found to be indicated in a request. A category may be assigned to a request in various ways. A statistical predictor may be used to assign a category to a request or query. A profile associated with a request may affect detection of a category. A category associated with a request may affect whether a named entity is indicated in a request.

A named entity database may be created which associates topics or tags, aliases, categories, and/or other information with a named entity. A named entity may be determined based on statistical information of a corpus of documents, media, etc. A weighting or priority may be assigned to a topic and/or category which may influence or affect a probability that an item will be selected responsive to a request. An action of a responder may be used to determine a category, topic and/or named entity associated with a query or request. A priority of a topic, named entity and/or category may be affected by a type of request. For example, requests for factual information may use a different topic relationship, weighting, and ranking criterion and/or algorithm than requests for subjective information.

In a system wherein users may submit questions and receive responses it is desirable that answers may be provided by other users. Systems such as Google and Yahoo Answers, Mosio, and Aardvark have been developed to attempt to use the intelligence of other users to provide answers to a user request. However, such systems have a difficult time to provide a timely answer, and often suffer from accuracy and credibility issues.

Systems such as the ChaCha® search service have been implemented using a human assistant to answer queries which cannot be answered by automated means. Such a system can overcome the problems of query latency and answer quality, but may require a higher level of human effort per answer. Consequently it may be difficult to provide responses at a cost similar to that enjoyed by fully automated search engines such as the Bing® or Google search engines.

A human assistant may provide a higher quality natural language response which is relevant to a user question, but it may take considerable effort to find factual information. For example, an assistant might receive a request, copy the request to a search engine, activate a search, investigate one or more search results, locate the requested information, reformat the information, and transmit the information back to a requester. ChaCha has developed various tools for assisting a human assistant in providing a response more rapidly.

Such tools may be effective aides, but may require training, and a sophisticated user interface to allow a human assistant to use the tools effectively. Tools created for expert searchers may be difficult to implement in a portable device which has a small display, limited processing power, and interfaces.

For these and other reasons, a method and system of providing search assistance would be greatly appreciated.

A system is provided which includes a user device submitting a request, a responder device receiving requests and information of answers, a server receiving and routing requests, resources such as an RSS feed, a database, a search engine, etc., which may include information relevant to a user request, and a database containing records of requests, keywords, users, responders, resources, queries, answers and other information created and/or modified during the operation of the embodiments.

When a query is received by a search system, a query may be analyzed to determine if an automated response to the query is suitable. When a query matches a stored or programmatically generated query, a stored response and information associated with a stored response may be obtained. A stored response may include a sponsored answer provided by an advertiser. A stored response may include a search result obtained by a human searcher responsive to a previous query. A human searcher may be an unsponsored searcher and/or may be a searcher sponsored by an advertiser and/or entity to respond to a query. A sponsored answer may be provided to a user prior to an unsponsored or organic search result.

If a programmatic response to a user request is not found, a request may be routed to a selected human assistant or responder. A responder may be provided with various tools for responding to a request. A default user interface for responding to a request may be determined based on a match of a user request to stored information. A category and a toolset may be provided based on whether a request is seeking publicly available information. A user interface may be determined based on whether a request is seeking temporal information.

A toolset provided to a responder or answerer may be selected based on a type associated with a request. If it is determined that a request is seeking factual information, a toolset which is designed to provide factual information may be provided to a responder. A responder may be selected based on whether a request is seeking factual information. A toolset may be selected based on a type of information requested. If a request is determined to be seeking temporal information, a toolset associated with frequently updated resources such as an RSS feed regarding weather, or sports information may be provided. If a request is determined to be seeking reference information, a toolset for accessing factual statements extracted from various sources selected based on a request may be provided.

A suggested response to a request may be obtained. A suggested response may be extracted from a resource such as a web page. A resource from which a response is extracted may be ranked based on an occurrence of a named entity, keyword, and/or other content of a request. A suggested response which is grammatically correct and is a sentence which includes a named entity and/or other content associated with a request may be ranked higher. A suggested response may be obtained based on a resource which includes structured data such as a table. A suggested response may be a sentence constructed based on content of structured data. A suggested response associated with a table may have a lower ranking than a suggested response which is directly found in a resource. A response associated with a table may be extracted if a suggested response which has a sufficiently high ranking is not found in text of a pre-determined number of resources.

A suggested response may be obtained based on a data feed such as an RSS feed or database. If a query associated with a data feed matches a request with the exception of a token, a tool associated with the data feed and an indicator of the mismatching token may be provided. If a request matches a stored query, and an element of the request is ambiguous, a disambiguated query, a response associated with the query and/or the request may be presented.

A system Is provided which includes a user device submitting a request, a responder device receiving requests and information of answers, a server receiving and routing requests, resources such as an RSS feed, a database, a search engine, etc., which may include information relevant to a user request, and a database containing records of requests, keywords, users, responders, resources, queries, answers and other information created and/or modified during the operation of the embodiments.

A system is implemented to allow a user to submit a query and receive a response. A response may include any type of media such as text, URL's, audio, video, etc. A response may be produced automatically and/or using the assistance of a person. A query may be submitted using any suitable device and/or communication service such as SMS, MMS, voice, Instant Messaging, VoIP, internet packet communication, email, etc.

Processing of a query may be divided into various layers. A first layer may consist of automated processing of a query. Automated processing of a query may include comparison of a query to a database, analysis of a query using semantic techniques, pattern matching, etc. which may be used to determine a response to the query. Results of automated processing such as categorization, spelling correction, named entity extraction, location association, etc. may be stored for later use.

A second layer of processing of a query may include a human assistant who analyzes the query or “expediter”. An expediter uses the human ability to recognize context in order to determine a response to a query. An expediter may be provided with relevant context of a query, and offered various options for responding to the query. In its simplest form, an expediter might be presented with a question and two or more options for responding to the question. An expediter may be provided with a rich toolset which provides a greater depth and breadth of responses which may be interactive. In at least one embodiment, an expediter may be provided with responses from a predetermined set of resources.

A third layer of processing of a query may include a human assistant who responds to the query or “searcher”. A searcher may receive an interpreted query, information of a source of the query, and be provided with resources for performing a search responsive to a query. A searcher may formulate a response based on an interpreted query, and submit the response for delivery to a user responsive to the query. In at least one embodiment, a searcher may receive information of resources which may be used to provide a response, and/or resources which are excluded from providing a response.

A resource may be characterized according to various parameters. A resource may be evaluated based on a number of responses obtained from and/or using the resource. A resource may be evaluated based on a number of times that a response obtained from the resource is reused. A resource may be evaluated based on an affiliate relationship between a provider of the resource and a provider of search services.

As used herein, a “request” means a request for information, products, and/or services. A request or search request or query may include various types of media, and may be provided by any user system which may establish communication with a server and/or other devices associated with a search service. A request may be referred to as a “search request”, “search query”, or “query”.

A “user” is a person who submits a request and may receive any type of information responsive to a request. A user may be any person or entity. A “guide” is a person who assists in processing a request. A guide may be referred to as a “provider”, “searcher”, “human searcher”, “expediter”, “transcriber”, “specialist” or “generalist”. Guides may be assigned various roles. A guide who transcribes a user request from one form to another may be referred to as a transcriber. A guide who reviews a query, determines a most likely response, and may modify a query may be referred to as an expediter or “ambassador”. A guide who performs a search for queries associated with a specific category may be referred to as a specialist. A guide who performs a search for queries regardless of category may be referred to as a generalist. Any guide may perform any role.

An “advertiser” is any person and/or entity which may provide promotional information or “advertisements” to be delivered to a user. An advertisement may take various forms and/or may include media of any sort which can be delivered to a user device. A “result”, “response”, “answer”, or “search result” is any information which has been determined to be a response to a request. A result may include an advertisement. A result may be any information which is provided as a response to a request. A “resource” or “search resource” may be any source of information which may provide a search result and/or other information. A resource may include a search engine, a web server, a software application, an API, printed media, an RSS feed, streaming media, a web page, a database, etc. A “profile” may be any information associated with a person such as demographic data, geographic data, personality data, affiliations, etc. A result may be an “organic” result which is produced by a search which has no intentional bias applied. A result may be a “sponsored” result which is provided and/or approved by a provider with a commercial interest in the response and/or providing the response to a user based on a request for information associated with the sponsored answer or sponsored result.

A human assistant such as an expediter may select a search result associated with a previous query and/or an automated resource. A search result selected by a human assistant may be indicated as a sponsored result and/or an organic result. A human assistant may be presented with sponsored results, organic results, and/or a mixture of organic and sponsored results. An expediter may be associated with a sponsor, and may be presented with sponsored results associated with the sponsor.

The terms voice and speech are used interchangeably herein. A user, a guide and/or a search system may establish a communication session using a voice service, a messaging service such as Short Messaging Service (SMS), Enhanced Messaging Service (EMS), Multi-media Messaging Service (MMS), Instant Messaging (IM), email, an internet portal or web page, an application, regular mail and/or any other suitable type of communication. A connection or communication session may be established using any device which is capable of utilizing a communication service. For example, a wireless device such as a cell phone, PDA, smart phone, etc., might be used to establish a communication session using voice, SMS, IM, email and/or internet protocols. A desktop, laptop or server system might be used to establish a communication session using IM, email, SMS, MMS, etc. A landline phone, a specialized communication terminal, and/or any other communication device might be used to establish a communication session.

Communication between a user, a guide and/or a search system may include conversion of text to speech and speech to text. Any type of media which can be sent and/or received using a communication system may be part of a communication session. A communication session may be conducted using any or all communication services associated with a user, a guide, and/or a search system. Any communication session may include communication via multiple services and/or devices. For example, a request may be submitted as a voice query, which might indicate an image located on a resource accessible to a user. A voice query might be converted to a text message, the image might be processed in order to associate a tag and/or other images with the image, and a response might be provided as a spoken reply to a mobile phone associated with a user, and a video presentation which is accessible via a high-speed connection that might be delivered to a browser functionality of a different user device.

An advertisement may be transmitted, including during any or all communication sessions. A guide, a user, a search result, a resource, a responder, an advertiser and/or a request may be rated. Rating information may be obtained from a user, a guide, an advertiser and/or an administrator of a search system. Rating information may be used to select a user, a guide, a request, a result, a responder, an advertiser, and/or any item based on information associated with an item indicated in a database. A search service may be compensated by advertising revenue. Advertising and/or content may be delivered to a user and/or a guide using any communication service associated with a user and/or a guide. An advertiser may request and obtain information regarding usage, users, demographics, affiliations, etc. associated with queries, keywords, categories, resources etc. and may submit sponsored answers and associate sponsored answers with queries based on information provided.

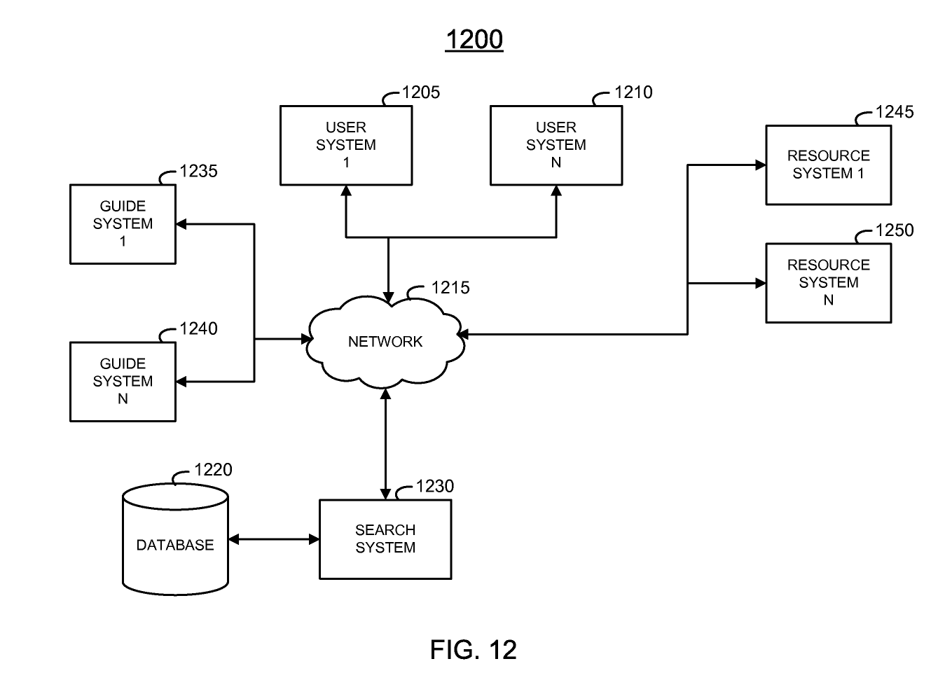

As illustrated in FIG. 12, system 1200 includes user systems 1205, 1210, a network 1215 such as the Internet, a search system 1230, a database 1220, which may comprise various records, guide systems 1235, 1240, resource systems 1245, 1250.

While only a few systems associated with a user, a resource, a sponsor and a guide are depicted in FIG. 12 it is within the scope of the disclosure for multiple systems for a user, resource, sponsor and guide to be utilized. In particular it is envisioned that many user, resource, sponsor and guide systems may be implemented. The search system 1230 may be a composed of many components as described further herein.

Any user system (e.g. the user system 1205) can be used, to submit a request to the search system 1230 and/or receive a result and/or other information. Any user system may receive a response, and/or may provide compensation to the search system 1230.

The network 1215 may be a global public network of networks (i.e., the Internet) and/or may consist in whole or in part of one or more private networks and communicatively couples the user systems 1205, 1210, the guide systems 1235, 1240, and the resource systems 1245, 1250 with the other components of the system such as the search system 1230, and the database 1220. The network 1215 may include one or more wireless networks which may enable wireless communication between the various elements of the system 1200. For example, the search system 1230 may receive messages which may be routed via a wireless network controlled by a wireless service to the user systems 1205, 1210. A wireless service may receive messages from the guide systems 1235, 1240 via a wireless network which is a part of the network 1215, and provide the messages to the search system 1230 via an internet connection which is part of the network 1215. Similarly a voice communication via wired and/or wireless communication might be established between any elements of the system 1200.

The search system 1230 allows interaction to occur among the user systems 1205, 1210, the guide systems 1235, 1240, the resource systems 1245, 1250. For example, a request can be transmitted from the user system 1205 to the search system 1230, which may provide information obtained from the database 1220, which may include an advertisement to the user system 1205. Similarly, a search result from a searcher operating the guide system 1235 and/or the resource system 1245 might be routed to the search system 1230, which might process the search result, formulate a response and provide a message to the user system 1205. Any type of communication between users, resources, sponsors and/or guides may be mediated and/or facilitated by the search system 1230, and/or other elements of the system 1200.

The search system 1230 is communicatively coupled with the database 1220. As will be described herein in further detail below, the database 1220 includes data that is processed in association with operation of the embodiments. Although FIG. 12 illustrates the database 1220 as a separate component of the system, the database 1220 may be integrated with the search system 1230. Further, the records maintained in the database 1220 may be stored in any typical manner, including in a Network Attached Storage (NAS), a Storage Area Network (SAN), RAID, etc., using any typical or proprietary database software such as DB2®, Informix®, Microsoft® SQLServer™, MySQL®, Oracle®, etc., and may also be a distributed database on more than one server. Elements of the database 1220 may reside in any suitable elements of the system 1200. Any or all elements of the system 1200 may include any or the entirety of the database 1220.

The user systems 1205, 1210, the guide systems 1235, 1240, the resource systems 1245, 1250, and the search system 1230 may include equipment, software, systems and personnel required to send and/or receive messages between a user system 1205, 1210, the guide systems 1235, 1240, the resource systems 1245, 1250 and/or the search system 1230 using the network 1215. The database 1220 includes information which may allow the search system 1230 to establish communication between any or all of the elements of the system 1200.

A user system, a guide system, a resource system, a resource system and/or a search system may be a desktop, portable, or tablet PC or Mace, a mobile phone, a smart phone, a PDA, a server system, a landline phone, a specialized communication terminal, a terminal connected to a mainframe, or any other communication hardware and/or system. For example, servers such as the PowerEdge® 2900 by Dell, or the BladeCenterJS22 by IBM, or equivalent systems might be used to implement elements of the search system 1230. The search system 1230 may utilize an operating system (OS) such as Microsoft Windows XP, or Linux, etc. Voice routing and packet switching may be accomplished using well established technologies such as those provided by Cisco, or other networking companies. After being presented with the disclosure herein, one of ordinary skill in the relevant art will immediately realize that any viable computer systems or communication devices known in the art may be used as user systems, resource systems, guide systems, and/or to implement the search system 1230.

A user may be identified by the search system 1230. When a user system, such as the user system 1205, establishes a communication session with the search system 1230, an identifier of a user system is determined. An identifier of a user system may be associated with other information regarding a user. A user system may be identified using an email address, a telephone number, an IM credential, a username, and/or any other identifier which may be used to associate information with a user. Multiple identifiers of a user may be associated with each other. Using information of communication services associated with a user, a communication session may be established between a user system such as the user system 1205 and a resource system, a guide system, and/or the search system 1230. Information such as a keyword, a category, a user profile, a request, a result, etc., may be associated with a user. A user may be required to provide profile information to the search system 1230. A user may elect to receive requests from the search system 1230. Parameters and/or attributes may be associated with a resource as will be further described herein below. Information of a user may be stored in the database 1220.

A guide may be required to register with the search system 1230. As part of a registration process, at least one communication method is associated with a guide. In at least one embodiment, a guide may register with the search system 1230 and establish a username and password which are associated with the guide. A guide may login to the search system 1230 using a web browser functionality of the guide system 1235 in order to communicate with the search system 1230. Multiple communication services may be associated with a guide and may allow a communication session to be established between a guide system such as the guide system 1235 and a user system, a resource system, a sponsor system, and/or the search system 1230. Multiple identifiers of a guide may be associated with each other. Information such as IM credentials, an email address, a phone number, a URL, a username, etc., of a guide may be identified which may allow the search system 1230 to establish a communication session between a guide system and a user system, a resource system, and/or the search system 1230.

When a guide registers with the search system 1230 the guide may be associated with one or more keywords, categories, profiles, and/or other information. Information associated with a guide may be stored in the database 1220 and may be used for various purposes. Information associated with a guide may be used to rank requests, resources, results, advertisements, sponsors and/or other information which may be presented to the guide. In at least one embodiment, payment information is associated with a guide. In at least one embodiment, a guide may be required to undergo testing to determine whether a guide is able to perform any tasks which may be required by the search system 1230. For example, a guide may be assigned to a role such as translator, transcriber, expediter, generalist, specialist, auditor, etc.

Records may be maintained in the database 1220 which may be used to record the status of various items. Such records may be used to aid the processing of requests and production of responses or answers. For example, a user may submit a request, which may describe a desired response, and provide access to information and/or materials needed to produce the response. Information indicated in a record may be combined with information in other records, and may be used to produce tables, as further described herein.

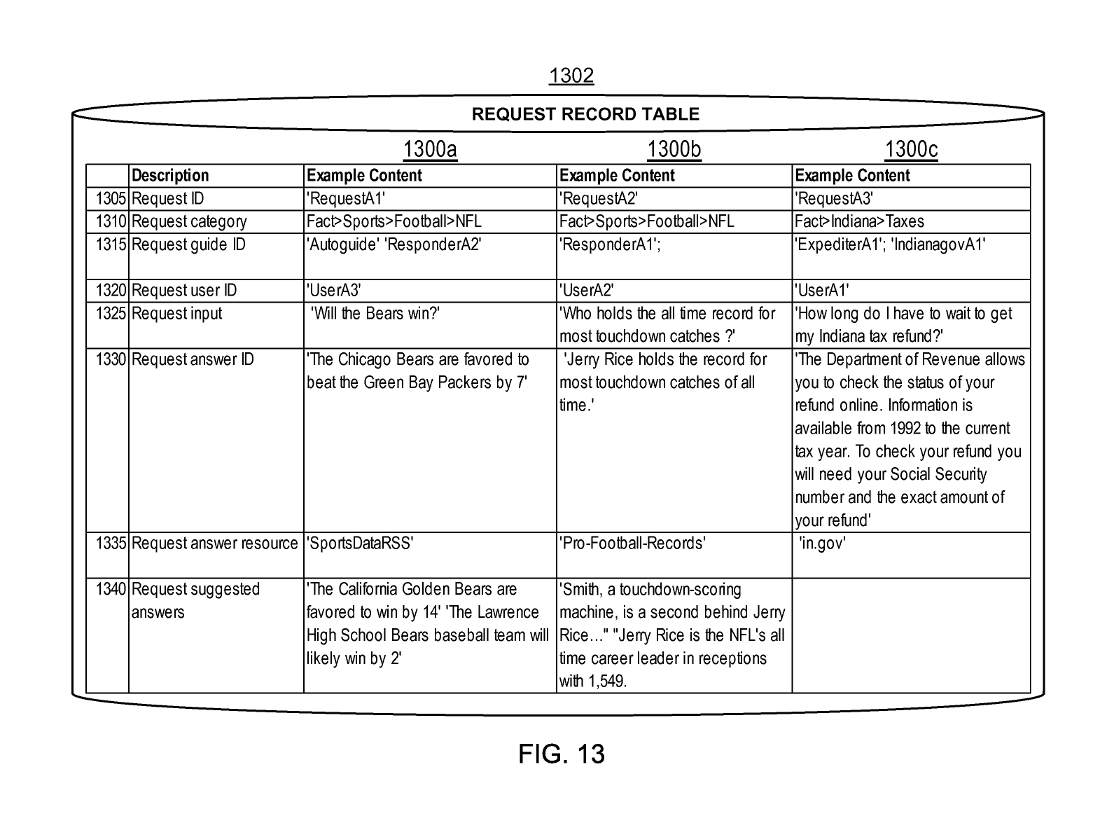

As illustrated in FIG. 13 an exemplary request record table 1302 which may comprise a number of request records is provided. One or more request records may be associated with or resident in the database 1220 (FIG. 12). The request record table 1302 may include information of requests which may be processed. The request records 1300 may include a request ID field 1305, a request category field 1310, a request guide ID field 1315, a request user ID field 1320, a request input field 1325, a request answer ID field 1330, a request answer resource field 1335, and a request suggested answers field 1340.

The request ID field 1305 includes an identifier of a request which is preferably unique and is preferably used consistently. A request ID serves to distinguish a request record associated with a request from a request record associated with other requests. Any number of characters, numbers, and/or other indicators may be used to indicate a request ID. In at least one embodiment, a request ID associated with a request is included in the request ID field 1305. In at least one embodiment, a random number is indicated in the request ID field 1305. Using the example in FIG. 13, ‘RequestA1’ is the request ID associated with the request record 1300a.

The request category field 1310 may include information of a category associated with a request. Information indicated in the request category field 1310 may be used to select an item associated with a request. For example, a category associated with a request may be used to rank guides who may be associated with the type of request. Likewise, a category associated with a request may be used to rank requests which may be presented to a guide or responder. A category associated with a request may be determined based on factors such as keywords of a query, a profile of a user, a selection of a person such as a responder or user, a user history, etc. A category associated with a system taxonomy may be indicated in the request category field 1310. A category may be associated with a request automatically and/or using the assistance of a person. Using the example in FIG. 13, ‘RequestA2’ may be categorized as ‘Fact>Sports>Football>NFL’ as indicated in the request record 1300b. This may indicate that a person or item associated with the category ‘NFL’ or ‘Sports’ may have a higher ranking for responding to ‘RequestA2’. A category of a request may be associated with a user submitting a request. Content of a request such as a keyword, named entity, etc. may be used to assign a category or type to a request.

The request guide ID field 1315 may include information of a number of guides or responders associated with a request. Content of the request guide ID field 1315 may be used to obtain information of a guide using a record such as a responder record. If a person is selected for a request, elects to receive a request, provides a response to a request, reviews a result of a request and/or completes a request, an identifier of the person may be indicated in the request guide ID field 1315. Using the example in FIG. 13, ‘Autoguide’ and ‘ResponderA2’ are associated with ‘RequestA1’. This may for example indicate that ‘RequestA1’ has been processed by ‘ResponderA2’ and an answer is provided by ‘Autoguide’ using information from ‘SportsDataRSS’.

The request user ID field 1320 may include information of a number of users associated with a request. Content of the request user ID field 1320 may be used to obtain information of a user associated with a request. For example, if a request is submitted by a user, an identifier of the user may be indicated in the request user ID field 1320. A request may not be associated with a user request. The search system 1230 (FIG. 12) may provide requests to persons which are not directly related to a user request. The search system 1230 may provide a request to a searcher based on a selection of a request by a sponsor. Using the example in FIG. 13, ‘UserA1’ is associated with ‘RequestA3’ and ‘UserA2’ is associated with ‘RequestA2’. This may indicate that ‘RequestA3’ was submitted by ‘UserA1’ while ‘RequestA2’ was submitted by ‘UserA2’.

The request input field 1325 may include information of a request. Content of the request input field 1325 may be provided to a person who accepts a request. Content of the request input field 1325 may include any type of information. For example, a pointer to audio, video, text, and/or other media may be indicated in the request input field 1325. As illustrated in FIG. 13, the query ‘How long do I have to wait to get my Indiana tax refund?’ is the request input associated with ‘RequestA3’, as indicated in the request record 1300c. In at least one embodiment, the request input field 1325 may indicate an original user request, a categorization, and a rewritten user request.

The request answer ID field 1330 may include information of a response associated with a request. Content of and/or indicated by the request answer ID field 1330 may be provided responsive to a request. Content of the request answer ID field 1330 may be stored in the database 1220 (FIG. 12). Content of the request answer ID field 1330 may be reviewed and/or rated by a user, a guide, and/or an administrator. As illustrated in FIG. 13, the response ‘The Department of Revenue allows you to check the status of your refund online. Information is available from 1992 to the current tax year. To check your refund you will need your Social Security number and the exact amount of your refund.’ is associated with ‘RequestA3’ as illustrated in the request record 1300c. While a text response to a query is used for the purposes of illustration, any type of media may be indicated in the request answer ID field 1330. In at least one embodiment, a text response and a URL associated with a source of the text response may be indicated in the request answer ID field 1330.

The request answer resource field 1335 may include information of a search resource associated with a request. Content of the request answer resource field 1335 may be used to select a resource which may provide a search result. For example, a responder and/or an automated process may cut a snippet of text from a web page indicated by content of the request answer resource field 1335 in order to create a response to a request. An answer may include various types of media such as text, images, audio, html, etc. Content of the request answer resource field 1335 may be produced automatically and/or using the assistance of a person. Using the example in FIG. 13, the resource ‘Pro-Football-Records’ is associated with ‘RequestA2’. This may indicated that an answer to a future request associated with ‘Fact>Sports>Football>NFL’ may obtain a suggested response based on a ranking of ‘Pro-Football-Records’ for the request, that a response or suggested answer was obtained using the resource, etc.

The request suggested answers field 1340 may include information of an answer associated with a request. Content of the request suggested answer field 1340 may be used for various purposes. For example, a suggested answer indicated in the request suggested answers field 1340 may be used to determine whether an answer is likely to correctly answer a query. For example, if content of the request suggested answers field 1340 is provided to a responder, the content may be presented in an order based on a ranking process. If a higher ranking suggested answer is selected as a preferred response to the request, it may be determined that a ranking process is effective. As illustrated in FIG. 13, the answers ‘The California Golden Bears are favored to win by 14’ and ‘The Lawrence High School Bears baseball team will likely win by 13’ are associated with ‘RequestA1’ as indicated by the request record 1300a. This may indicate that a possible interpretation of the query ‘Will the Bears win?’ might be associated with those answers since ‘Bears’ might indicate those sports teams as well as the ‘Chicago Bears’. Any number of suggested answers may be indicated in the request suggested answers field 1340.

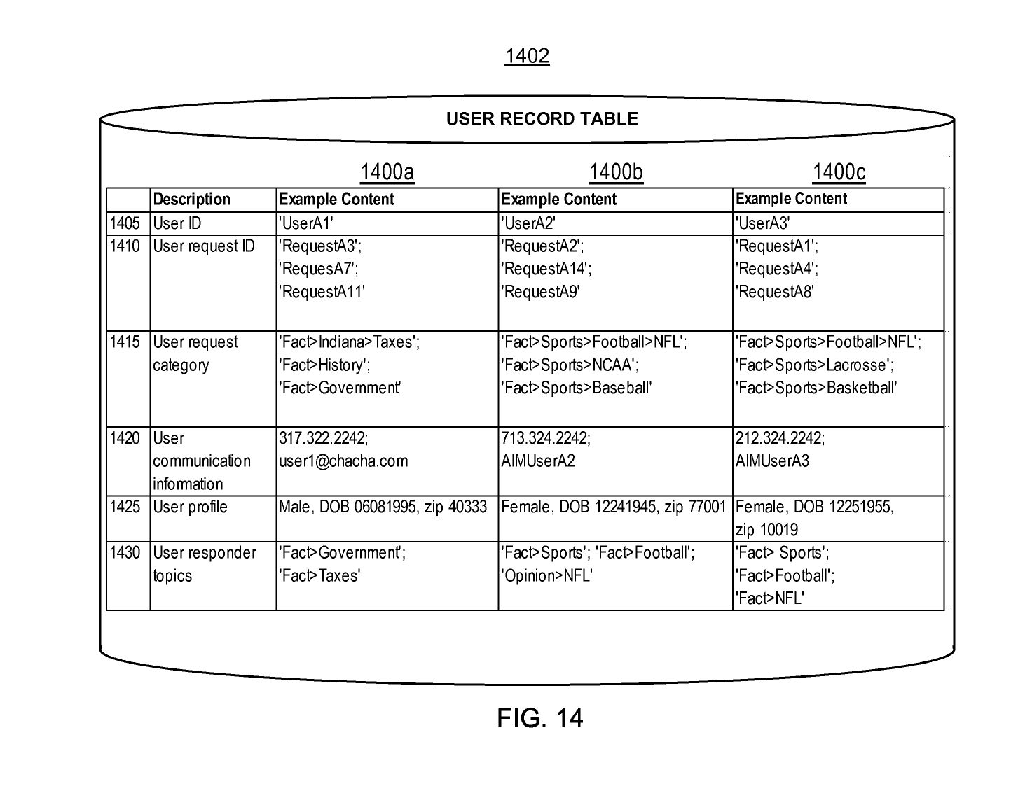

As illustrated in FIG. 14 an exemplary user record table 1402, which may comprise a number of user records is provided. One or more may be associated with or resident in the database 1220 (FIG. 12). The user record table 1402 may include information of users. The user records 1400 may include a user ID field 1405, a user request ID field 1410, a user request category field 1415, a user communication information field 1420, a user profile field 1425, and a user responder topics field 1430.

The user ID field 1405 includes an identifier of a user which is preferably unique and is preferably used consistently. A user ID serves to distinguish a user record associated with a user from a user record associated with other users. Any number of characters, numbers, and/or other indicators may be used to indicate a user ID. In at least one embodiment, a random number is indicated in the user ID field 1405. Using the example in FIG. 14, ‘UserA1’ is the user ID associated with the user record 1400a.

The user request ID field 1410 may include information of a number of requests associated with a user. A user request ID may be for example a pointer to a request record associated with a request submitted by a user. If a user submits a request, a request ID may be added to the user request ID field 1410. Using the example illustrated in FIG. 14, ‘RequestA2’, ‘RequestA14’, and ‘RequestA9’ are associated with ‘UserA2’ as indicated in the user record 1400b. This may indicate that ‘UserA2’ has submitted ‘RequestA2’, ‘RequestA14’, and ‘RequestA9’.

The user request category field 1415 may include information regarding a category or type associated with a user request. For example, if a request is directed to a type of processing or a category, etc. a type and/or category associated with the processing may be indicated in the user request category field 1415. In at least one embodiment, the user request ID field 1410 and the user request category field 1415 are linked by for example a pointer.

The user communication information field 1420 may include information of a number of communication services associated with a user. Any information which may be used to establish communication with a user may be indicated in the user communication information field 1420. For example, a telephone number, an email address, an IM credential, a URL, a username, a password, and/or other communication information may be indicated in the user communication information field 1420. Using the example in FIG. 14, the phone number ‘317.322.2242’ and the email ‘usera1@chacha.com’ are associated with ‘UserA1’.

The user profile field 1425 may include information of a profile associated with a user. For example, demographic, geographic, affiliation, personality, and/or other types of anthropic and/or other characteristic information may be associated with a user. A user may provide profile information as part of a registration process. User profile information may be obtained from a database provided by a third party. User profile information may be determined based on test, polling, query history, peer review, and/or other information associated with a user. Using the example illustrated in FIG. 14, ‘Female, DOB 12241945, zip 77001’ are associated with ‘UserA2’. Profile information may be used to match information provided by a user to other information. For example, a ranking of a guide for a query of a user may be adjusted based on a profile associated with the user. A sponsored answer might be modified based on geographic, demographic, etc. profile information of a user.

The user responder topics field 1430 may include information of a topic associated with a user for which the user may be selected as a responder. The user responder topics field 1430 may include topics for which a user has elected to receive questions and/or topics for which a user has requested not to receive questions. Content of the user responder topics field 1430 may be used to rate a user for a request. As illustrated in FIG. 14, a query associated with ‘Sports’ might be directed to ‘UserA2’ and ‘UserA3’. A user may elect to receive subjective and/or objective requests associated with a category.

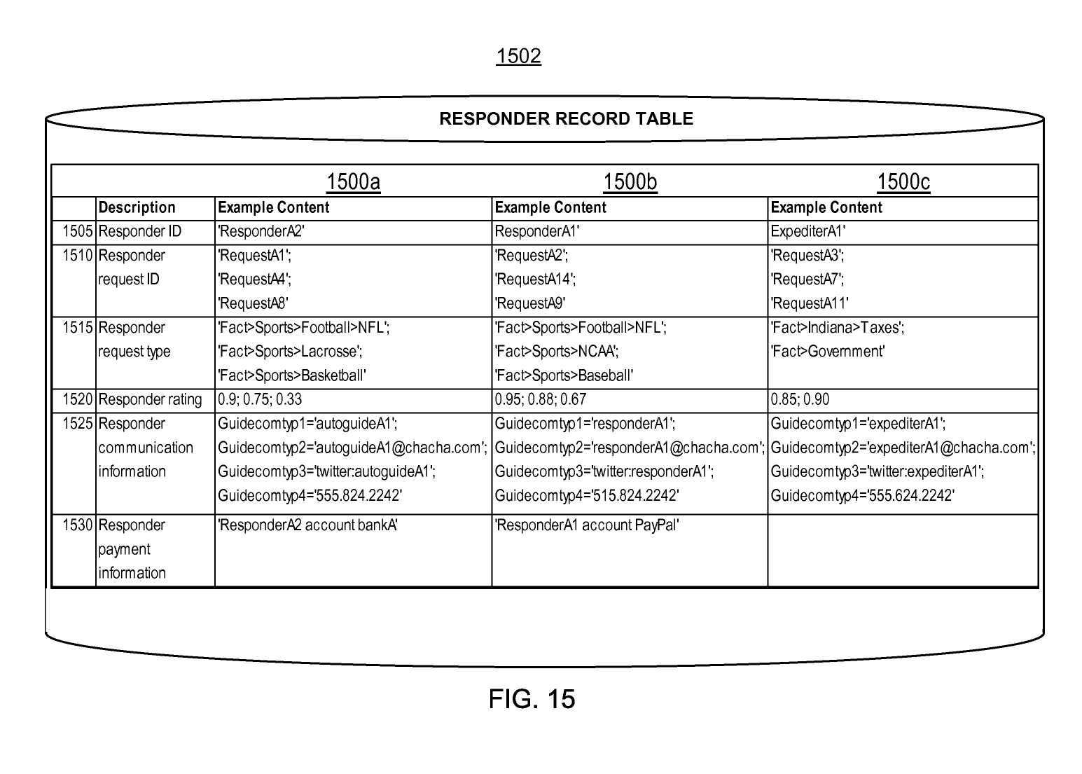

As illustrated in FIG. 15 an exemplary responder record table 1502 which may comprise a number of responder records is provided. One or more may be associated with or resident in the database 1220 (FIG. 12). The responder record table 1502 (FIG. 15) may include information of responders. The responder records 1500 may include a responder ID field 1505, a responder request ID field 1510, a responder request type field 1515, a responder rating field 1520, a responder communication information field 1525, and a responder payment information field 1530.

The responder ID field 1505 includes an identifier of a responder which is preferably unique and is preferably used consistently. A responder ID serves to distinguish a responder record associated with a responder from a responder record associated with other responders. Any number of characters, numbers, and/or other indicators may be used to indicate a responder ID. In at least one embodiment, a random number is indicated in the responder ID field 1505. In at least one embodiment, a pseudonym selected by a responder may be indicated in the responder ID field 1505. Using the example in FIG. 15, ‘ResponderA2’ is the responder ID associated with the responder record 1500a.

The responder request ID field 1510 may include information of a number of requests associated with a responder. Content of the responder request ID field 1510 may be used to obtain information of a request. A pointer to a request record may be indicated in the responder request ID field 1510. For example, if a user request has been determined to require a number of requests to be performed, the search system 1230 (FIG. 12) may assign a unique ID to the requests and may distribute information of the requests to guides or responders. Using the example in FIG. 15, ‘RequestA3’, ‘RequestA7’, and ‘RequestA11’ is associated with ‘ExpediterA1’ as indicated in the responder record 1500c. This may indicate that ‘ExpediterA1’ has expedited or handled ‘RequestA3’, ‘RequestA7’ and ‘RequestA11’.

The responder request type field 1515 may include information of a number of types of requests which may be processed by a responder. For example, a category and/or keyword associated with a request, a type of request, temporal information associated with a request, etc., which may be used to determine if a responder is to be presented with a request may be indicated in the responder request type field 1515. In at least one embodiment, a responder may be assigned to a particular type of request as part of a registration process. A responder may select a type of request which the responder may perform. A responder may be required to pass a test in order to be associated with a type of request. A responder may be assigned to a role such as expediter, searcher, etc., which may be indicated in the responder request type field 1515. A request indicating a keyword, topic, category, etc. may be directed to a responder. Using the example in FIG. 15, ‘ResponderA1’ is associated with ‘Fact>Sports>Football>NFL’, and ‘Fact>Sports’ as indicated in the responder record 1500b. This may for example indicate that ‘ResponderA1’ may be presented with and/or selected to respond to requests indicating those categories, keywords and/or topics.

The responder rating field 1520 may include information of a number of ratings associated with a responder. For example, quality, speed, peer review, etc., may be used to determine a rating of a responder. A rating of a responder may be used for purposes such as determining compensation for the responder (e.g., rights of the responder), selecting a responder to respond to a request, matching a request to a responder, etc. In at least one embodiment, the responder request type field 1515 and the responder rating field 1520 may be linked by, for example, a pointer. Using the example in FIG. 15, “ExpediterA1’ has a rating of ‘0.85’ associated with ‘Fact>Indiana>Taxes’, and a rating of ‘0.90’ associated with ‘Fact>Government’ which may be used to rank ‘ExpediterA1’ versus other responders associated with the request types ‘Fact>Indiana>Taxes’ and ‘Fact>Government’.

The responder communication information field 1525 may include information of a number of communication services associated with a responder. For example, a user name and password, an email address, an IM credential, a phone number, a web page, a physical address, etc., may be indicated in the guide communication information field 1525. Using the example illustrated in FIG. 15, ‘ResponderA1’ is associated with the login ID ‘respondera1’, the email ‘respondera1@chacha.com’, the Twitter account ‘twitter.respondera1’, and the phone number ‘515.824.2242’ as indicated in the responder record 1500b. This may indicated that ‘ResponderA1’ may be contacted using the associated communication services.

The responder payment information field 1530 may include information of a payment method associated with a responder. For example, banking information, a PayPal® account, a Western Union® account, etc., may be indicated in the responder payment information field 1530. Content of the responder payment information field 1530 may be used to provide compensation to a responder. For example, payment may be made by Automated Clearing House (ACH), wire transfer, etc., using information indicated in the guide payment information field 1530. As indicated in FIG. 15, the guide “‘ResponderA2’ is associated with “ResponderA2 account BankA’ which may indicate that the sponsor is providing compensation to ‘ResponderA2.

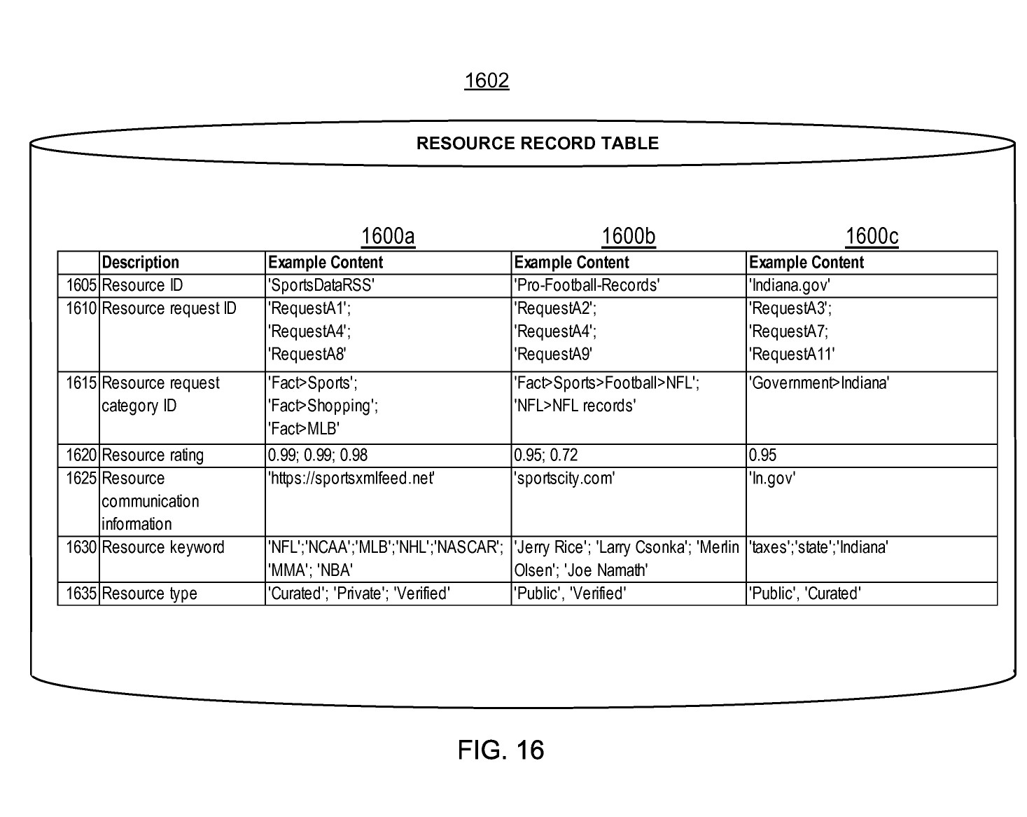

As illustrated in FIG. 16 an exemplary resource record table 1602 which may comprise a number of resource records is provided. One or more may be associated with or resident in the database 1220 (FIG. 12). The resource record table 1602 (FIG. 16) may include information of resources. The resource records 1600 may include a resource ID field 1605, a resource request ID field 1610, a resource request category ID field 1615, a resource rating field 1620, a resource communication information field 1625, a resource keyword field 1630, and a resource type field 1635.

The resource ID field 1605 includes an identifier of a resource which is preferably unique and is preferably used consistently. A resource ID serves to distinguish a resource record associated with a resource from a resource record associated with other resources. Any number of characters, numbers, and/or other indicators may be used to indicate a resource ID. Using the example in FIG. 16, ‘SportsDataRSS’ is the resource ID associated with the resource record 1600a. This may indicate that ‘SportsDataRSS’ has been used to produce a search result, and is accessible to a responder.

The resource request ID field 1610 may include information of a number of requests associated with a resource. Content of the resource request ID field 1610 may be used to obtain information of a request. For example, if a resource has been used to respond to a request, an identifier of the request may be indicated in the resource request ID field 1610. Using the example in FIG. 16, ‘RequestA2’, ‘RequestA4’ and ‘RequestA9’ are associated with the resource ‘Pro-Football-Records’ as indicated in the resource record 1600b. This may indicate that ‘Pro-Football-Records’ has been utilized to respond ‘RequestA2’, ‘RequestA4’, and ‘RequestA9’.

The resource request category ID field 1615 may include information of a number of categories of requests which may be processed by a resource. For example, a category and/or keyword associated with a request, a type of request, profile, etc., which may be used to determine if a resource is to be presented to a guide or responder for a request may be indicated in the resource request category ID field 1615. In at least one embodiment, a resource may be assigned to a category of request as part of a registration process. A resource may be associated with a user, a group of users, an access right, an advertiser or sponsor, etc. A provider of a resource may select a type and/or category of request for which the resource may be used and/or required. A resource may be associated with a category based on a selection by an administrator, based on success rates of obtaining or providing answers, etc. Using the example in FIG. 16, ‘In.gov’ is associated with the category ‘Government>Indiana’ as indicated by the resource record 1600c.

The resource rating field 1620 may include information of a number of ratings associated with a resource. For example, a rating of a resource may be based on ratings of answers produced using the resource, a contractual agreement, an affiliation, temporal information such as time spent by guides, responders, users, etc. A rating of a resource may be used to select a resource which is provided to a responder or guide, to rank a response associated with a resource, etc. In at least one embodiment, the resource request category ID field 1615 and the resource rating field 1620 may be linked by, for example, a pointer. Using the example in FIG. 16, ‘SportsDataRSS’ has a rating of ‘0.99’ associated with ‘Fact>Sports’. A resource may have a rating corresponding to various categories, types of information, types of tasks, keywords, etc. A rating of a resource may be determined based on statistics associated with the resource such as whether a suggested answer is found using the resource, success associated with URL's sharing a common top-level or second level domain name, etc. A ranking or rating of a resource may affect a ranking or rating of an answer obtained from a resource.

The resource communication information field 1625 may include information of a number of communication services associated with a resource. For example, a user name and password, an email address, an IM credential, a phone number, a web page, a physical address, etc., may be indicated in the resource communication information field 1625. A communication service indicated in the resource communication information field 1625 may for example be used to indicate a service by which a resource may be accessed. Using the example illustrated in FIG. 16, the URL <<sportscity.com>> is associated with ‘Pro-Football-Records’. This may indicate that a query associated with ‘Fact>Sports>Football>NFL’ may be submitted to that URL by for example an API, or may be used to extract and/or rank content found at that URL, as illustrated in the resource record 1600b.

The resource keyword field 1630 may include information of a number of keywords associated with a resource. A match to a keyword indicated in the resource keyword field 1630 may affect a probability that a request will receive a response associated with a resource. For example, a match may prohibit a query from receiving a result from a resource, may increase a ranking of a resource, may be used to associate a category with a request, may identify a resource to be provided to a guide, etc. In at least one embodiment, keywords included in requests for which a resource has provided an answer may be more highly ranked for a category associated with the query and the resource. A sponsor may select keywords associated with a resource provided by the sponsor.

The resource type field 1635 may include information of a number of types or characteristics associated with a resource. A type may include an indication of an access right, a commercial arrangement, a preference, quality of content, source of content, etc. A searcher or responder may elect to associate a resource with a type. A system administrator may associate a type with a resource. A provider of a resource may designate a type associated with the resource as part of a registration process. Using the example in FIG. 16, ‘Indiana.gov’ is a ‘Public’, ‘Curated’ resource as illustrated in the resource record 1600c. This may indicate that content of the resource is controlled, and that the resource is accessible to the general public. A type associated with a resource may be used to determine a toolset provided to a responder for a query associated with a type.

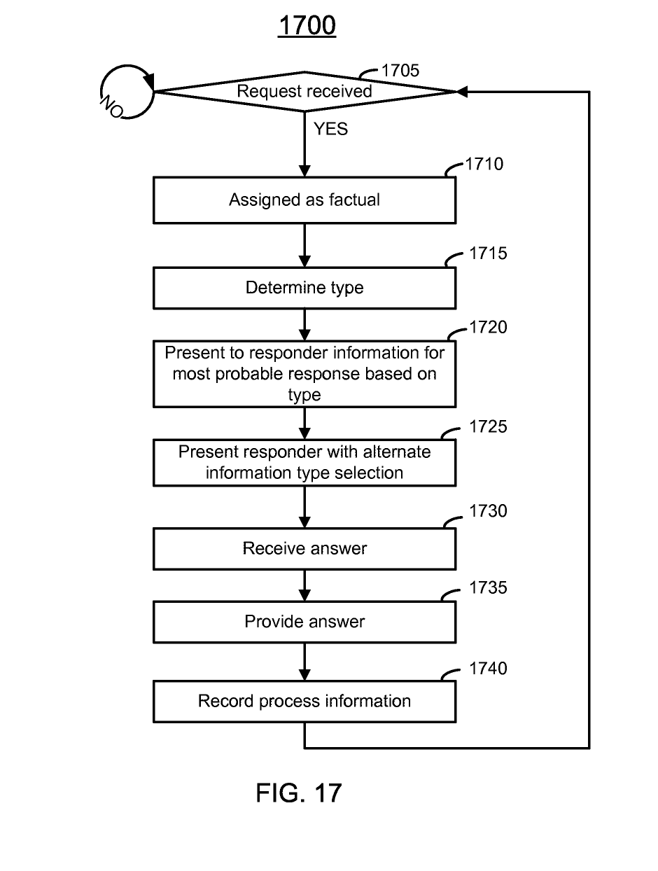

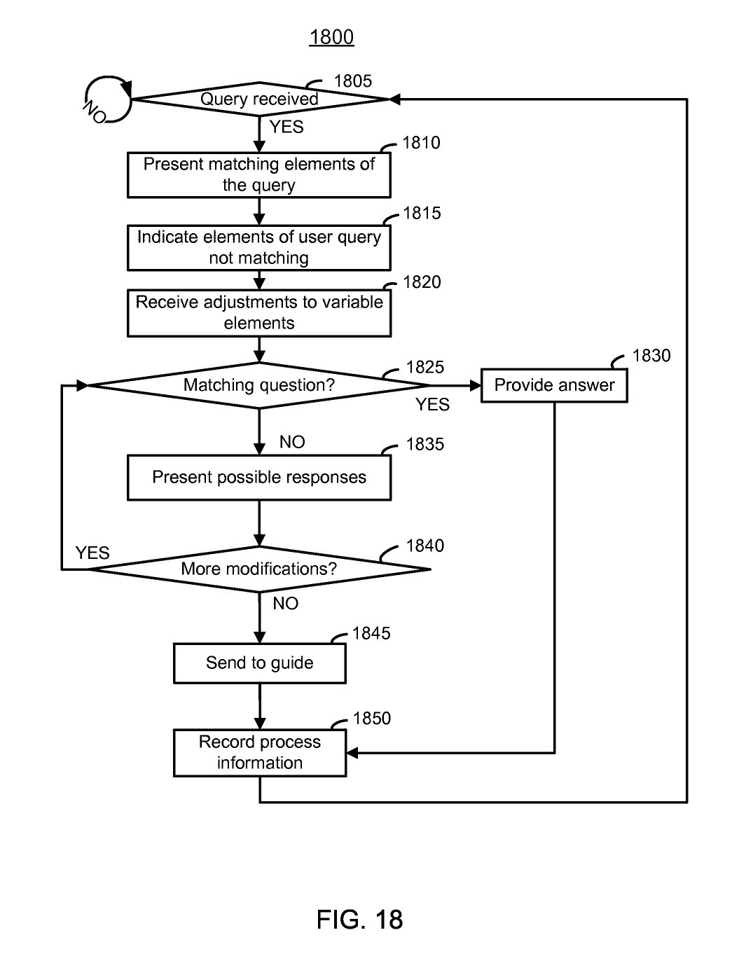

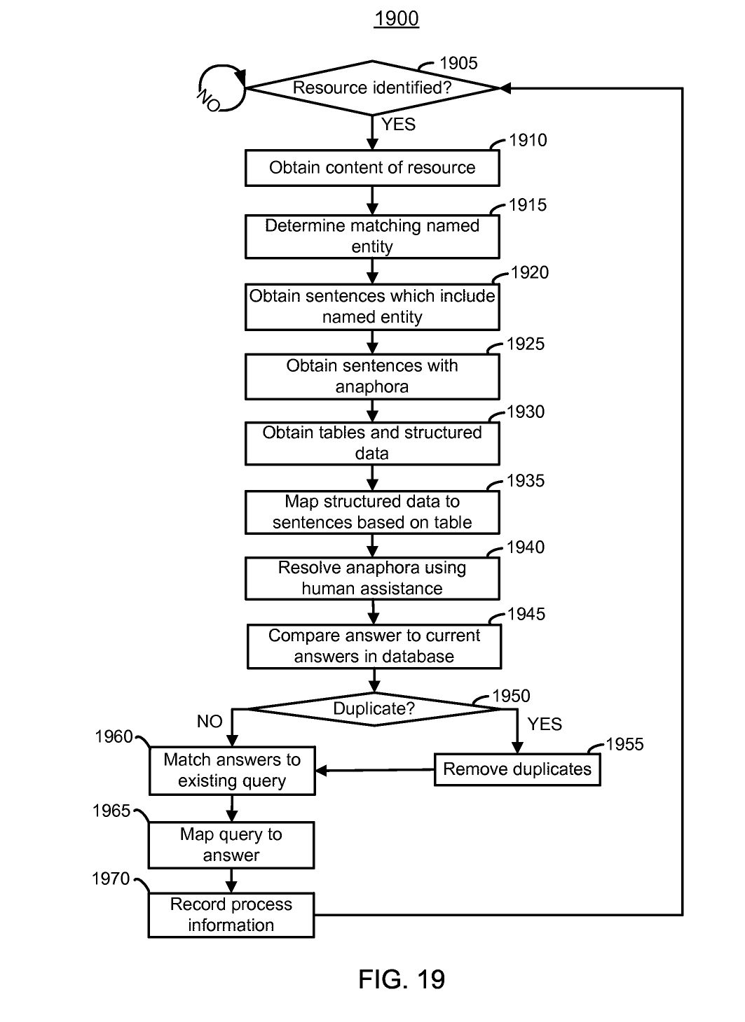

As illustrated in FIG. 17, a process 1700 for providing an answer is provided. The process 1700 may be performed in whole or in part by any suitable element of the system 1200 (FIG. 12). In at least one embodiment, the process 1700 is operative on a server associated with the search system 1230. A request may be a request for an automated answer, a human assisted answer and/or a combination thereof. The process 1700 may be incorporated with a process such as the process illustrated in FIG. 18 and/or the process illustrated in FIG. 19.

In operation 1705 (FIG. 17) a determination is made as to whether a request is received. If it is determined in operation 1705 that a request is not received, control remains at operation 1705 and process 1700 continues. If it is determined in operation 1705 that a request is received, control is passed to operation 1710 and process 1700 continues.

The determination in operation 1705 may be made using various criteria. In at least one embodiment, if a message is received at a system associated with the search system 1230 (FIG. 12), it may be determined that a request is received. For example, if an email message, an SMS, EMS, and/or MMS message, an IM, an IP message, and/or a voice message is received at an address associated with the search system 1230, it may be determined that a request is received. If a message is received at a server associated with the search system 1230, it may be determined that a request is received.

In operation 1710 a query is assigned as factual. A query may be determined to be factual based on a control activated by a user, a responder may indicate that a query is seeking a fact, a guide may decide that a query is factual, etc. For example, a responder may decide that a query about Indiana taxes is seeking factual information. Control is passed to operation 1715 and process 1700 continues.

In operation 1715, a type is determined. A question type may be determined based on various factors which may include, named entity tagging, Bayesian categorization, user designation, semantic processing, etc. Any number of types may be determined for a request. A responder, guide, automation, etc. may determine a type associated with a question. A type associated with a request may be used to determine an interface or toolset which is provided to a responder. A type may be determined based on a probability function associated with a request or query. For example, if a query matches a previous query, or a named entity of a query matches a named entity associated with a type, a probability that a request is associated with a type may be increased. Types associated with a request may be ranked and a toolset and/or response may be presented to a responder based on the ranking. Control is passed to operation 1720 and process 1700 continues.

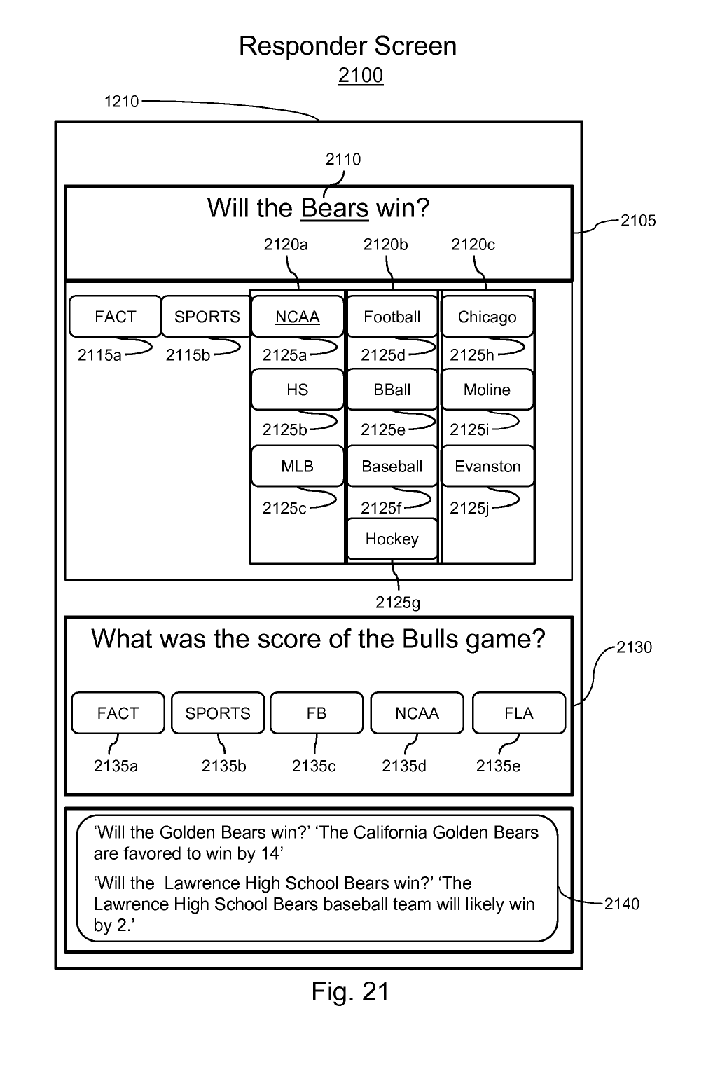

In operation 1720, a responder is presented with information for a most probable response based on a type. A responder may be presented with a tool associated with a type for which a responder has previously responded and/or a topic selected by the responder. A type may be associated with a user interface. For example, if a user request matches a stored request, a user interface associated a stored answer and/or the stored request may be provided. Likewise, a responder may be presented with tools associated with real-time information if a query is determined to be seeking temporal information. For example, if content of a user request is frequently associated with sports scores, weather information, or other temporally varying content, a user interface associated with temporal information such as the GUI 2100 (FIG. 21) may be presented. A category associated with a query may affect a type assigned to a request. For example, if the category ‘Weather’ is associated with a request a GUI providing temporal weather information (not shown) might be presented to a responder. Control is passed to operation 1725 and process 1700 continues.

In operation 1725 a responder is presented with alternate information type selection. If a responder is presented with a toolset which is not suitable for a request, a responder may be able to select a different toolset. For example, other lower-ranking types may be indicated to a responder in order that a responder may select a more suitable type and a more suitable tool for responding to a request. For example if a name of a sports team is indicated in a request, a type associated with temporal information of scores might be selected. However, it the query is determined to be seeking historical trivia, a responder may be presented with navigation controls to permit easy navigation to a historical trivia responder interface. Control is passed to operation 1730 and process 1700 continues.

In operation 1730, an answer is received. If an answer is received from a predetermined number of responders it may be determined that an answer is received. If a time interval has elapsed, it may be determined that an answer is received. If a user has accepted a response, sent a message to a responder, or otherwise responded to an answer, it may be determined that an answer is received. If a number of responders have declined a request or indicated that a request is inappropriate, it may be determined that an answer is received. Control is passed to operation 1735 and process 1700 continues.

In operation 1735, an answer is provided. Any number of answers may be provided. A highest ranking answer may be provided. A sponsored answer may be provided. An advertisement may be provided as a portion or the entirety of an answer. Control is passed to operation 1740 and process 1700 continues.

In operation 1740, process information is recorded. Information of a request, an answer, a category, a keyword, a resource, a resource, a toolset, a user, a sponsor, a guide, a responder, a rating, a ranking, etc. may be recorded. A stored response may be rated, ranked, or deleted. Information of a type may be stored. For example, if a responder responds using a user interface associated with a type a probability associated with the type and information of a request may be adjusted. In at least one embodiment, process information is recorded in the database 1220 (FIG. 12). Control is passed to operation 1705 and process 1700 continues.

As illustrated in FIG. 18, a process 1800 for obtaining an answer is provided. The process 1800 may be performed in whole or in part by any suitable element of the system 1200 (FIG. 12). In at least one embodiment, the process 1800 is operative on a server associated with the search system 1230 (FIG. 12). An answer may be obtained from a responder and any or all of the process 1800 may be operative on a device such as the guide system 1235 and/or the user system 1210.

In operation 1805 (FIG. 18) a determination is made as to whether a query is received. If it is determined in operation 1805 that a query is not received, control remains at operation 1805 and process 1800 continues. If it is determined in operation 1805 that a query is received, control is passed to operation 1810 and process 1800 continues.

The determination in operation 1805 may be made using various criteria. In at least one embodiment, if a message is received at a system associated with the search system 1230 (FIG. 1), it may be determined that a request is received. For example, if an email message, an SMS, EMS, and/or MMS message, an IM, an IP message, and/or a voice message is received at an address associated with the search system 1230, it may be determined that a request is received. If a message is received at a server associated with the search system 1230, it may be determined that a query is received.

In operation 1810, matching elements of a query are presented. A matching element of a query may be determined based on queries recorded in a data base, previous answers, a template associated with a resource, a database of named entities, etc. A part of a request matching a previous query may be indicated by green text, non-underlined text or other ways of distinguishing elements of a query which are well known in the art. A GUI such as that depicted in FIG. 21 may be provided. A query may be a stored query, a template associated with a type, etc. Control is passed to operation 1815 and process 1800 continues.

In operation 1815, elements of a user query not matching are indicated. Any element of a query not matching a reference query such as a query in a database and/or a template may be indicated. An element may be indicated by underlined text, change in color of text, or any suitable way of distinguishing an element. An element may include an image, video, etc. Control is passed to operation 1820 and process 1800 continues.

In operation 1820, adjustments to variable elements are received. A responder may determine a query does not match anything in a database that the responder knows etc. A match may not occur because of a misspelling, a responder has not heard of the word, a word is used for something else, etc. For example, if a user submits a request regarding ‘Jerry Rice’ it may not be matched to a reference query including ‘Jerry Rice’. A responder might be presented with a drop-down menu or other interface element which would enable substitution of ‘Jerry’ for ‘Gerry’. Any elements of a query may be identified as a non-matching element. Any number of alternative elements may be provided. Alternatives may be presented in an order based on probability of matching a reference query. Control is passed to operation 1825 and process 1800 continues.

In operation 1825 a determination is made as to whether a matching question is found. If it is determined in operation 1825 a matching question is found, control is passed to operation 1830 and process 1800 continues. If it is determined in operation 1820 that a matching question is found, control is passed to operation 1835 and process 1800 continues.

The determination in operation 1825 may be made based on various criteria. For example, if a responder has selected an alternative which matches a stored query and/or a template for which an answer exists, it may be determined that a matching question is found. If a responder selects an alternative which maps to a question for which an answer is not available, it may be determined that a matching question is not found. Any suitable criteria may be used to determine whether a matching question is found.

In operation 1830 an answer is provided. An answer may be provided in various ways. For example an answer may be presented via a device which submitted a request, an answer may be stored in the database 1220 (FIG. 12), and/or an answer may be presented to a device determined by a user submitting a request. Control is passed to operation 1850 and process 1800 continues.

In operation 1835 possible responses are presented. A possible response may be one that closely matches a question in a data base, a response may be that there is no answer for a matching question, a response may be a snippet extracted from a resource, a response of a search engine, etc. A possible or suggested response may be presented in an order based on a ranking of the response. Control is passed to operation 1840 and process 1800 continues.

In operation 1840 a determination is made as to whether more modifications are received. If in operation 1830 it is determined that more modifications are received control is passed to operation 1825 and process 1800 continues. If in operation 1840 it is determined that more modifications are not received control is passed to operation 1845 and process 1800 continues.

The determination in operation 1840 may be made based various factors. For example, if a responder does not make changes or adjustments to an element of a query for a pre-determined time period, activates a control, selects a suggested response, etc. it may be determined that no more modifications are received. If a responder rejects a possible response, it may be determined that no more modifications are received.

In operation 1845, a query is sent to a guide. A question may be sent to a guide if a match was not obtained, an answer was not found, a time interval which has elapsed from the submission of the query is too long, etc. A guide may perform a search provide an answer. A guide may determine that a question does not match a question stored in a database and a guide may store a question for a future search. Control is passed to operation 1850 and operation 1800 continues.

In operation 1850, process information is recorded. Information of a request, an answer, a category, a keyword, a resource, a user, a sponsor, a guide, a responder, a rating, a ranking, etc. may be recorded. A stored response may be rated, ranked, or deleted. For example, if a stored response is rejected by a responder, a ranking of a response for a request, keyword, type, named entity, etc. may be modified. In at least one embodiment, process information is recorded in the database 1220 (FIG. 12). Control is passed to operation 1805 and process 1800 continues.

As illustrated in FIG. 19 a process 1900 for obtaining potential responses to a request from a resource is provided. A response may be identified and recorded for a future query. Information of a resource from which a response was obtained may be stored and/or modified. A number of sentences which may be used to respond to a query or “buds” may be obtained from a resource. The process 1900 may be performed in whole or in part by any suitable element of the system 1200 (FIG. 12). In at least one embodiment, the process 1900 is operative on a server associated with the search system 1230. A resource may be a live feed, information stored in a database, a web page, a media server, an RSS feed, etc. and may be identified by a server such as the search system 1230 (FIG. 12).

In operation 1905 a determination is made as to whether a resource is identified. If in operation 1905 it is determined that a resource is not identified, control remains at operation 1905 and process 1900 continues. If in operation 1905 it is determined that a resource is identified, control is passed to operation 1910 and process 1900 continues.

The determination in operation 1905 may be made based on various criteria. For example, a resource may be identified based on a POST operation made to a server associated with the search system 1230. A resource may be identified based on response to a POST operation. For example, the search system 1230 may deliver a query to a server associated with a search engine which may include any and/or all of a request for information. If a search engine server responds with a search result such as a URL, the search system 1230 may identify the URL as a resource which may be relevant to a query. A resource may be identified based on content of another resource. For example, if a web page is obtained which is associated with a keyword or named entity of a request and the web page includes a link to a resource, it may be determined that a resource is identified.

In operation 1910 content of a resource is obtained. Content may be obtained by sending a request to a server based on a URL. A query including a named entity may be submitted to a search engine, and a URL associated with a response of a search engine may be used to obtain content of a resource. Content of a resource may be obtained by submitting a query to an API associated with a resource. Content of a resource may be obtained based on an action of a responder and/or a user. Control is passed to operation 1915 and process 1900 continues.

In operation 1915 a matching named entity is determined. A system such as the system 1200 (FIG. 12) may simply determine whether a named entity is contained in a resource. A named entity which is to be matched may be determined in various ways. A match of a database of named entities to a named entity in a query may determine a matching named entity. Similarly, a list of named entities which are to matched within a resource may be provided when a particular type of information associated with the named entity is desired to be obtained. If a query includes a generic term such as ‘dog’, ‘touchdown’ or ‘record’, a resource may be scanned to determine if a named entity which is associated with those terms is found in a resource. A list of named entities may be maintained in a database such as the database 1220 (FIG. 12) which may associate a named entity with keywords which may be matched to a request. A matching named entity may be determined based on frequency of the named entity in a corpus such as a corpus of resources and/or a corpus of queries. Control is passed to operation 1920 and process 1900 continues.

In operation 1920 sentences which include a named entity are obtained. A sentence including a named entity may include an answer to a query, but a resource may also refer to information of a named entity having no correlation to a query. A match to a named entity may not guarantee a sentence in a source is an answer, but does ensure that the sentence is an answer which relates to a named entity. For example, a named entity such as ‘Jerry Rice’ may occur in a sentence in a resource, but the sentence may not reflect Jerry Rice is the leader in touchdown receptions, which is a fact sought by a request. A resource may contain hidden text which may not be visible when a page is rendered in a browser. A sentence contained in a source page html may provide an appropriate sentence to be used even if the sentence does not appear on a webpage as rendered by a browser. For example, the sentence ‘Jerry Rice holds the record for most tds of all time’ may be found in the page source for ‘sportscity.com’, but this sentence is not rendered by a browser application receiving the web page content. Control is passed to operation 1925 and process 1900 continues.

In operation 1925 sentences with anaphora are obtained. A sentence with anaphora may indicate an unresolved use of a pronoun. In general use of a pronoun in a resource may indicate that the pronoun refers to a subject of an article. However, this interpretation may be uncertain. A bud may be extracted which is a complete proper sentence, but includes a pronoun such as ‘he’ or ‘it’. Similarly, a use of a generic term such as ‘the team’ or ‘the riders’ is anaphora since a specific named entity cannot be assigned to that noun phrase. For example, a sentence or sentence ‘bud’ which may state “he is the reception touchdown leader” may not explicitly include the named entity ‘Jerry Rice’, but instead uses the pronoun ‘he’. A responder may understand this refers to Jerry Rice based on a URL, context, images, and/or other information which indicates that the sentence was found in a resource associated with ‘Jerry Rice’. Control is passed to operation 1930 and process 1900 continues.

In operation 1930 tables and structured data are obtained. Tables and other types of structured data which are included in a resource may be difficult to decode properly in order to create an answer which is accurate and grammatically proper. For this reason, such data may be less reliable than a sentence which has been extracted from human readable text of a web page. Structured and tabular data may be obtained by parsing for suitable html structures in content of a web page or resource. Control is passed to operation 1935 and process 1900 continues.

In operation 1935 structured data is mapped to sentences based on a table. Data contained in a table may be difficult to analyze and may be difficult to use in forming a sentence. A machine may be required to parse the xml or code of a webpage and examine headers of a table. A machine may unreliably correlate headers to data contained in a table which may create an incorrect ‘bud’. A header of a column in a table may not lend itself to constructing sentences, there may be an error, the words may not appear at all and/or the sentence may be incorrect. For example, a table contained in the resource ‘sportscity.com’ may not state in a sentence “Jerry Rice holds the record for most touchdowns of all time” but may instead provide a table where the content may be ‘Jerry Rice, years 1985-2004, for three teams, scored 197 touchdowns’. A sentence generated by a machine reading a table may sound less than natural and may make a determination as to whether the answer is correct more difficult. Control is passed to operation 1940 and process 1900 continues.

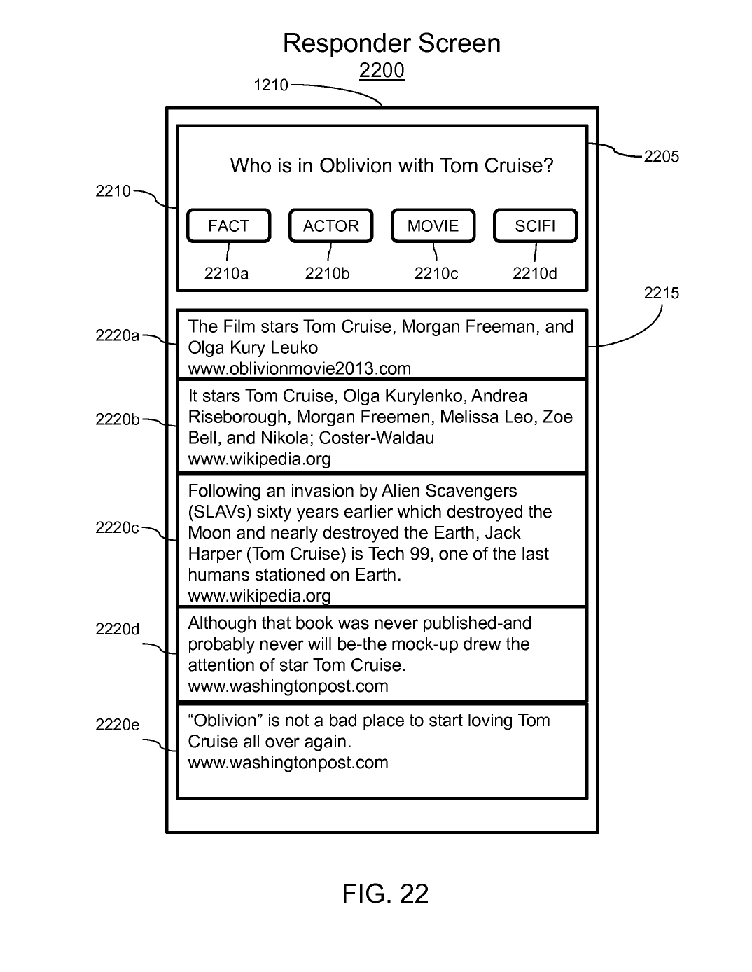

In operation 1940 anaphora is resolved using human assistance. In order to resolve an anaphora, a bud which includes an anaphora and an indication of a source of a bud may be presented to a person. A person may read a bud or sentence and examine context provided to determine a disambiguated meaning of an anaphora based on context surrounding a bud. An exemplary user interface for resolving anaphora is illustrated in FIG. 22. If anaphora does not exist, no action may be taken. Control is passed to operation 1945 and process 1900 continues.

In operation 1945 an answer is compared to current answers. A database such as the database 1220 (FIG. 12) may contain multiple sentences or answers which may or may not be associated with a query. The search system 1230 may compare a bud obtained from a resource to sentences contained in a database to determine which answer may similar to the bud. In particular if a query is seeking factual information, a more recent answer may be more accurate. An answer may be considered superior to a bud using various criteria such as: how recently a bud was obtained, age of a resource used to obtain a bud, relevancy ranking of a resource from which a bud was obtained for a query, a number of named entities included in a bud, etc. For example, if a resource provides a sentence such as ‘It stars Tom Cruise, Olga Kurylenko, Andrea Riseborough, Morgan Freeman, Melissa Leo, Zoe Bell, and Nikola Coster-Waldau’ that bud might be determined to be superior to the sentence ‘The film stars Tom Cruise, Morgan Freeman, and Olga Kury Leuko’ due to a larger number of named entities present in the bud. Control is passed to operation 1950 and process 1900 continues.

In operation 1950 a determination is made as to whether a duplicate is received. If it is determined in operation 1950 a duplicate is received, control passes to operation 1955 and process 1900 continues. If it is determined in operation 1950 that a duplicate is not received, control is passed to operation 1960 and process 1900 continues.

The determination in operation 1950 may be made in various ways. A duplicate may be determined based on answers recorded in a database, previous queries, etc. If a stored answer matches a sentence exactly, it may be determined that the sentence is a duplicate answer. If a stored answer differs from a sentence by more than one token it may be determined that the sentence is not a duplicate. A duplicate may also be determined based on recognizing keywords, stop words, named entities, synonyms, morphisms, etc. which are found in existing answers and buds retrieved.

In operation 1955 duplicates are removed. A duplicate may be removed if a response already exists in a system such as the system 1200 (FIG. 12). A duplicate may consist of a response used to answer an identical question, a similar question, a type of question, etc. A criteria for duplication may be based on a type of answer sought. For example, a factual answer may have a broader duplication criterion than a subjective answer. A duplicate may or may not be a good answer for a query, but may match a query and may be presented to a human responder with a closely matching answer to determine whether an answer is a duplicate. The system 1200 may check to see if an answer includes a named entity of a query, or may compare a category, classification, or keyword of a sentence. Any number of existing queries and/or buds or potential answers may be determined to be a duplicate and may be removed. A response matching an existing response may be removed and only the most appropriate response saved. Control is passed to operation 1960 and process 1900 continues.

In operation 1960 answers are matched to an existing query. A database such as database 1220 (FIG. 12) may contain multiple queries which may have been answered, unanswered, incorrectly answered, etc. A query may be in need of a new answer, a better answer, additional answers, etc. A query may be matched to a query associated with a response containing similar information which may be presented as an answer or potential answer. Control is passed to operation 1965 and process 1900 continues.

In operation 1965 a query is mapped to an answer. Sentences which may be potential answers may be mapped to queries which have not been submitted. Sentences or buds may be used immediately to answer a query. For example, if a query was presented about Tom Cruise's costars in Oblivion, a database may already contain a sentence stating ‘The film stars Tom Cruise, Morgan Freeman, and Olga Kury Leuko’ and the sentence may be provided to a user and/or a responder as a potential answer to the query. Any number of queries may be mapped to an answer. Answers may be presented in an order based on a ranking of the answer for the query and/or a request determined to match a query. Control is passed to operation 1970 and process 1900 continues.

In operation 1970, process information is recorded. Information of a request may be recorded. A stored response may be rated, ranked, or deleted. In at least one embodiment, process information is recorded in the database 1220 (FIG. 12). A sentence may be stored in a database even if it does not match an existing query, and may be recorded for a future possible answer if a query is received which may match the sentence. A rating or ranking of a response based on responses obtained from resources may be adjusted and/or recorded. Control is passed to operation 1905 and process 1900 continues.

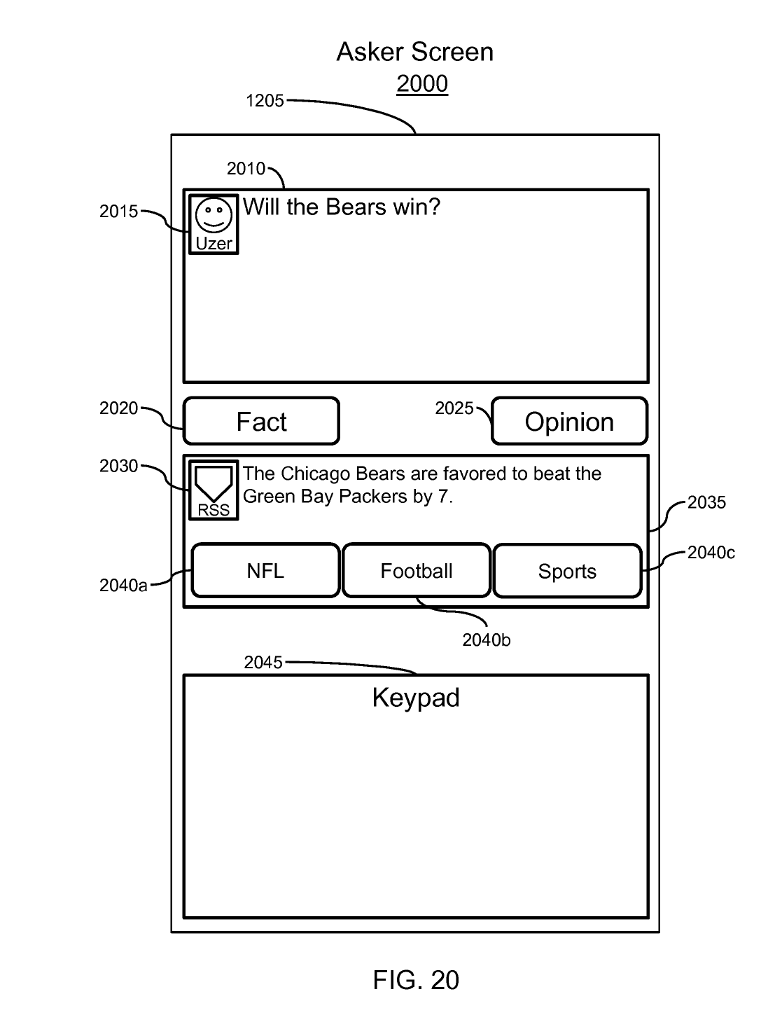

As illustrated in FIG. 20 an exemplary GUI 2000 for submitting a request is provided. The query submission GUI 2000 may be provided to a user. The GUI 2000 may be presented using a system such as the user system 1205 (FIG. 12). The GUI 2000 may be used to submit any type of request. The GUI 2000 may include a query entry area 2010, a user identifier 2015, a factual query indicator 2020, an opinion query indicator 2025, a responder indicator 2030, a response indicator 2035, topic indicators 2040a-2040c, and a user input control 2045.

The request entry area 2010 may be used to indicate information of a request. The user indicator 2015 may be used to indicate information of a user submitting a request. The factual query indicator 2020 may be used to indicate that a request is a request for factual information. Activation of the factual query indicator 2020 may cause a request indicated in the request entry area 2010 to be associated with the type ‘Fact’. Activation of the opinion query indicator 2025 may indicate that a request is a request for subjective information. The responder indicator 2030 may be used to indicate a source of a response. The response indicator 2035 may be used to indicate a response associated with a request indicated in the request indicator 2010. A requester may indicate which topic type the query relates to by choosing a topic type indicator. The topic type indicators 2040a-2040c may indicate that the answer ‘The Chicago Bears are favored to beat the Green Bay Packers by 7’ is associated with ‘NFL’, ‘Football’ and ‘Sports’. The user input control 2045 may be used to submit a request. While a keypad is used for purposes of illustration, any user input device which is well known in the art may be used to implement the user input control 2045.

As illustrated in FIG. 21 an exemplary GUI 2100 for responding to a query which partially matches a stored query is provided. The GUI 2100 may be presented using a device such as the user system 1210. The query indicator 2105 may be used to indicate a current user request. The topic indicators 2115a and 2115b may indicate topics which are determined with high confidence for a query. The variable topic indicators 2120a, 2120b, and 2120c may be used to allow a responder to change a query indicated in the query indicator 2105 to match an existing query. For example an ambiguous element of a query may be indicated by an ambiguity indicator 2110 such as the ‘Bears’ ambiguity indicator 2110. The variable topic indicators 2120a-2120c may be used to select information which may make a query more definite, easier to answer, more complete, etc. Option indicators 2125a-2125j may be provided to offer a selection from a list of possible options rather than requiring knowledge of possible options for a refinement of a query. As illustrated in FIG. 21, selection of the ‘NCAA’ option indicator 2125a may determine a query ‘Will the Bears win?’ relates to NCAA as indicated by the underlined text in the option indicator 2125a. The previous query indicator field 2130 may indicate a question or possibly several questions which a user has submitted, which may relate to a query indicated in the query indicator 2105. Information of a category, type, topic, etc. of a previous query may be presented in the previous query metadata indicators 2135a-2135e. For example, the previous query metadata indicators 2135a and 2135b match the query type indicators in 2115a and 2115b which may indicate a criterion by which the previous query was chosen. Possible queries and responses for a query constructed using the GUI 2100 may be provided a potential responses window 2140. Potential responses may be obtained by, for example, submitting a query to an API associated with a data feed which may produce a response based on a query indicated in the potential responses window 2140 and/or other elements of the GUI 2100.

As illustrated in FIG. 22 an exemplary GUI 2200 for responding to a query is provided. GUI 2200 may be presented when ‘bud’ answers which include anaphora match a query indicated in a request indicator 2205 were found to match a query. Query tag indicators 2210a-2210d may indicate categories and/or tags associated with a query. An answer window 2215 may indicate answers found to match the query in the request indicator 2205. For example the query tag indicator 2210d indicates the query ‘Who is in Oblivion with Tom Cruise?’ may be related to ‘SCIFI’. The answer window 2215 may include bud indicators 2220a-2220e which match or partially match a request in the request indicator 2205, but may include anaphora. For example the bud activator 2220a contains information of the answer ‘The Film stars Tom Cruise, Morgan Freeman, and Olga Kury Leuko and an indicator of the source of the ‘bud’ (i.e., <<‘www.oblivionmovie2013.com’>>). The bud provided in the bud activator 2220a contains an anaphora which is linked to the movie Oblivion as indicated by the URL containing the name of the movie. A responder may activate a respective ‘bud’ indicator which may cause the bud to be linked to the query indicated in the query indicator 2205 and the anaphora may be replaced with the named entity indicated in a query (e.g., ‘Oblivion’ since Tom Cruise is a person, not a thing) when a bud is provided as an answer. The bud activators 2220a-2220e may be activated by ‘swiping’, tapping, or other user inputs as is are well known in the art.

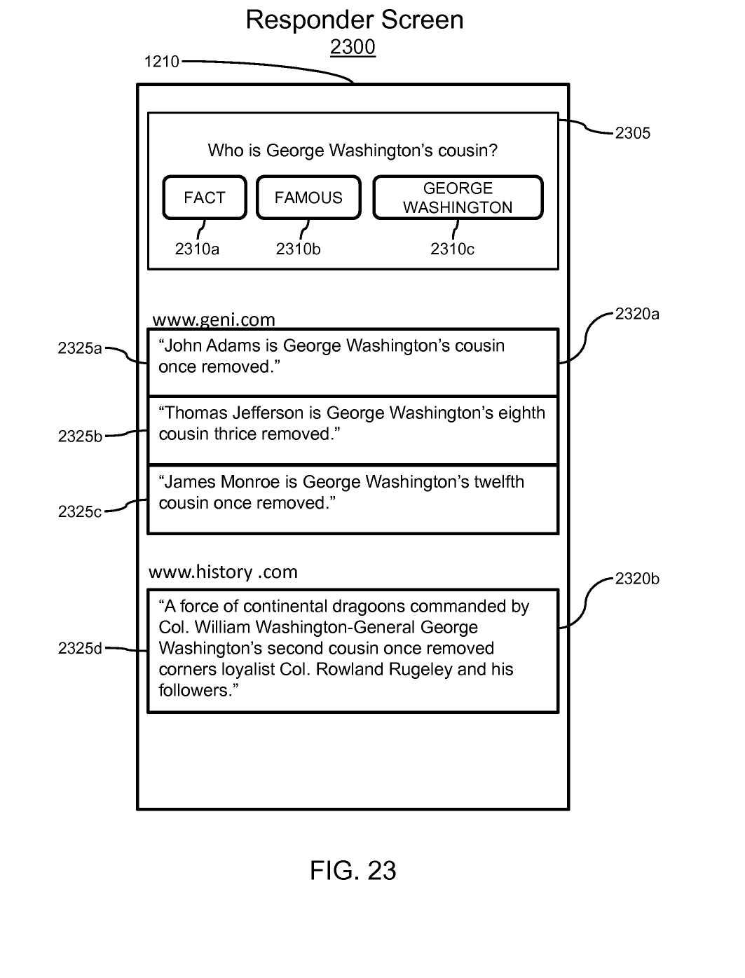

As illustrated in FIG. 23 an exemplary GUI 2300 for responding to a query is provided. The GUI 2300 may be presented when answers match a query indicated in the request indicator 2305. The GUI 2300 may be provided using a device such as the user system 1210 (FIG. 12). Query type indicators 2310a, 2310b, and 2310c may be used to indicate a category, tag, type, topic, etc. associated with a query indicated in the request indicator 2305. Resource result windows 2320a, 2320b may be provided which may show answers which are sentences which match a request which were found in a resource identified for a request which may have been located using a process such as the process 1900 (FIG. 19). For example, the answer activator 2325a provides the sentence ‘John Adams is George Washington's cousin once removed.’ from ‘<<www.geni.com>>’. The answer indicator 2325a indicates an answer which is a match to a named entity and keywords of a query indicated in the query in the query indicator 2305 and therefore it is probable this sentence may be a correct answer. Activation of the answer indicators 2325a-2325d may cause an answer indicated to be provided as a response to a request.

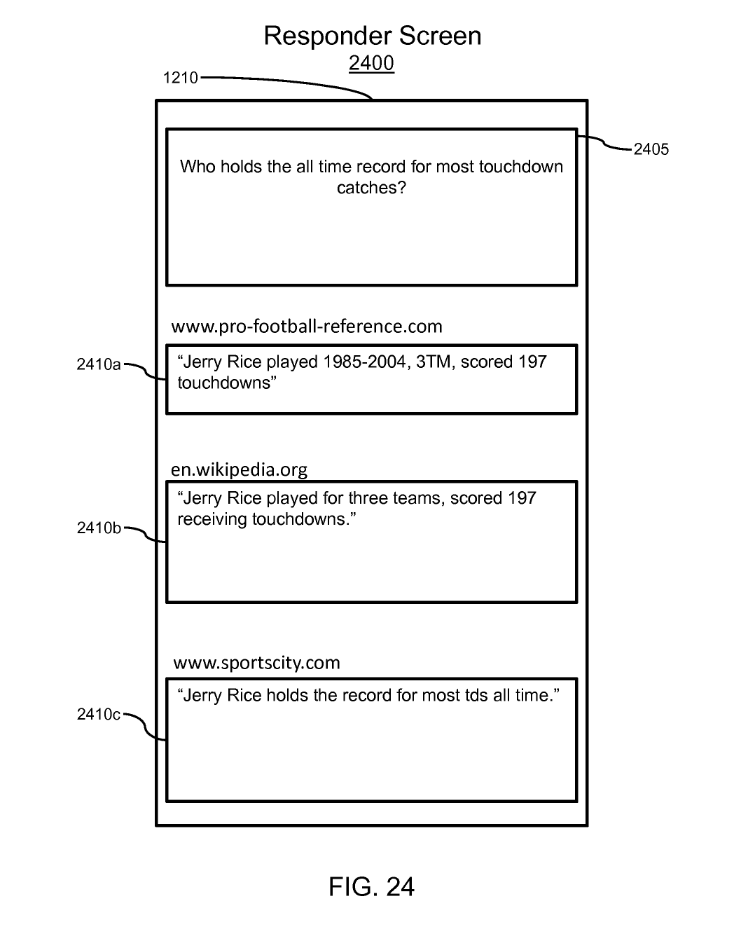

As illustrated in FIG. 24 an exemplary GUI 2400 for responding to a query is provided. The GUI 2400 may be provided using a device such as the user system 1210 (FIG. 12). A query field 2405 contains information of a query asked by a user. As illustrated in FIG. 24, a query may contain a named entity but may not. For example, the query indicated in the query field 2405 does not include a named entity. Content of answers indicated in answer indicators 2410a, 2410b, and 2410c may be determined based various criteria. For example, sentences may be selected on ranking of sentences found in the resource, a ranking of a highest ranking sentence from a plurality of resources, and whether a resource is highly ranked for a query indicated in the request field 2405. For example, the resource associated with the bud indicated in the bud window 2410a, ‘www.pro-football-reference.com’ might contain information provided based on a table of the webpage found at that URL, but was not found in a sentence, which might decrease a ranking of the bud. The sentence indicated in the answer indicator 2410b might be extracted from structured data. The sentence indicated in the answer indicator 2410c might be obtained from hidden text. A website from which a response was obtained might affect an order of presentation of the answer indicator 2410. Activation of the answer indicators 2410a-2410c may cause content associated with the answer indicators 2410a-2410c to be provided as a response to the query indicated in query field 2405.

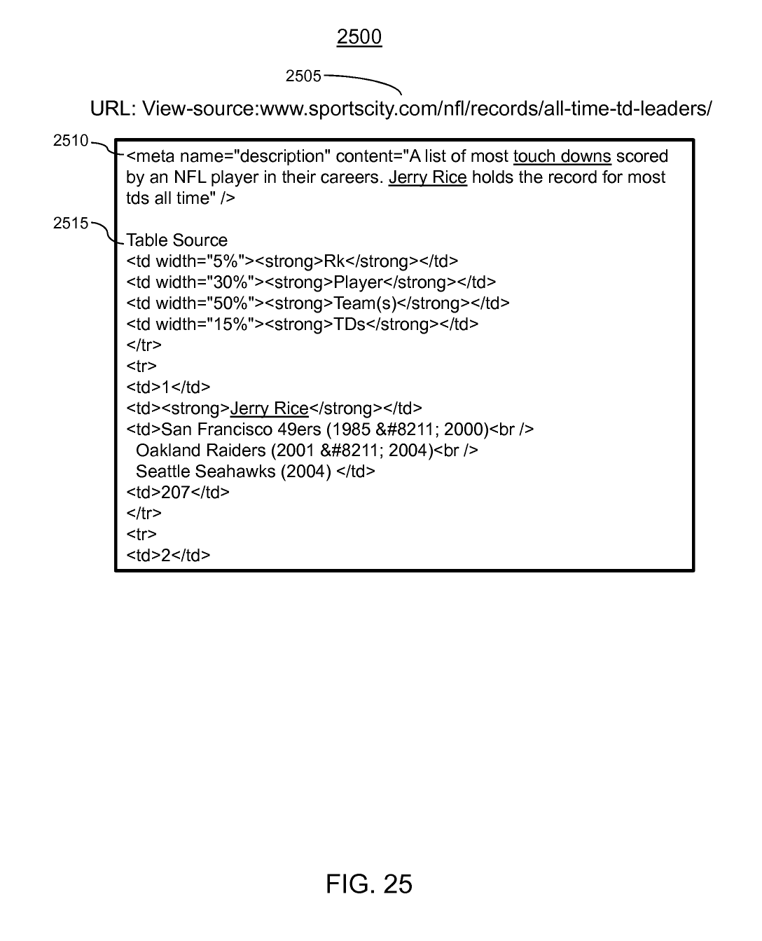

As illustrated in FIG. 25 a source code 2500 of a webpage which may be used to obtain an answer is provided. A sentence which is not visible when a web page is rendered may be found in the source code 2500. For example, the source URL 2505 may provide HTML or other types of data which is rendered by a browser. Text which is designated by the “meta name” tag 2510 will not be displayed in a browser. However, the sentence associated with the meta name tag 2510 may match keywords of a query such as “record” and “touchdowns”. Structured data of a table on the web page as indicated by the Table Source segment 2515 may provide relevant information as well. The “<td width= . . . </td>” may indicate title information of a table, which may be parsed to create a sentence. For example, “player” would indicate the subject of a sentence, “team” might indicate an object, and “TDs” another object. Thus a sentence such as “xxxx played for yyyy and scored zzz TDs” might be constructed for each named entity found in the table. A human may be able to view a table on a webpage and obtain the necessary information however this example illustrates the difficulty of parsing structured data from a web page. An API or other source may produce more reliable data, but may not recognize a query well and provide a null result in some instances.

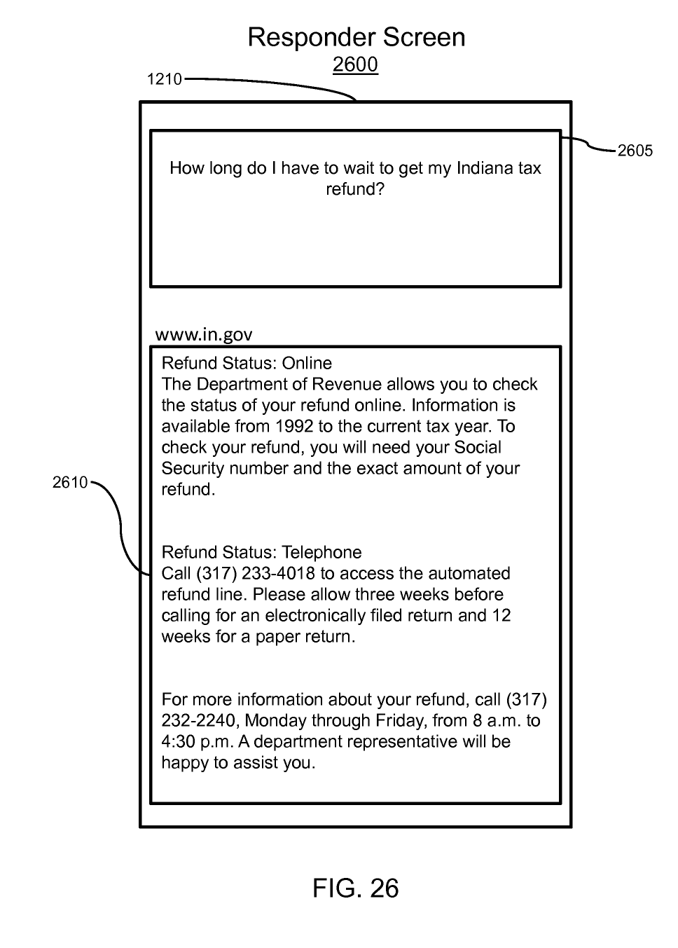

As illustrated in FIG. 26 an exemplary GUI 2600 for a restricted search is provided. A query is indicated in a query window 2605 and potential answers extracted from a restricted search space are provided in an answer window 2610. A restricted search may be used to search a limited space such as ‘www.in.gov’ which may contain potential answers or buds. A restricted search may be provided to a responder when an official agency or business resource is needed, when a responder is designated to answer questions from a specific resource, and/or when a user requests a restricted response.

A restricted search may be performed based on a source of a request. For example, if a request originates from a webpage ‘widget’, an app, etc. a restricted response may be indicated. A destination at which a request is received may indicate that a restricted search is requested. For example, if a message is received at a URL, an email address, an IM address, a short-code, etc., it may be that a restricted search is indicated. A restricted space for searching may be chosen based on matching of keywords of a query to keywords of sentences found within the resource. A restricted search space such as a business, agency, store, etc. may also have a designated responder associated with searches, as illustrated in the responder record 1500c (FIG. 15) wherein ‘ExpediterA1’ may be associated with an agency controlling the resource ‘in.gov’. When a user asks a question about a specific restricted search area, a designated responder may be presented with the GUI 2600 including matching answers or buds found in a resource included in a restricted search space. Selection of a bud may send a response indicated by in the bud window 2610 to a user. A restricted search is performed when the system 1200 (FIG. 12) limits a search of resources to only specific sites which contain matches and are authorized resources associated with any particular responder.

Using the embodiments described herein a method and system for assisting a responder in responding to a request is provided. A query may be analyzed to identify a most likely or probable type of information sought by a request. If a request is determined to be seeking factual information, a toolset associated with a factual response is provided. A toolset may be directed to various types of information and/or information resources. If a request is seeking temporal information, a toolset associated with a relevant data source such as an RSS feed, xml source of streaming data, and/or other real-time data may be provided.

If a request matches a stored request and/or a template, but includes unrecognized elements, a responder may be presented with a toolset which can be used to modify a request to match stored and/or template requests which may provide a response to a request.

A responder may be provided with sentences which are extracted from a group of resources. A group of resources may be identified in various ways. For example, if a query is directed to an entity a potential response or bud may be obtained from resources provided and/or designated by an entity. A group of resources may be determined based on a ranking of resources for a request. For example, based on a search engine ranking of a resource for a query based on a request, a set or group of resources may be identified for a request. Spidering or resources identified for a request may be used to identify resources based on links out of a resource.

A response may be obtained from a resource using various approaches. A response or potential answer may be obtained by automated analysis of content of a resource. For example, complete sentences which are found in content of a resource may be ranked based on keywords such as keywords of a request. A response which includes a named entity indicated in a request may be ranked more highly than a response which does not include a named entity. A bud or potential answer may be generated based on structured data provided by a resource. Tables indicated in a resource may be parsed to identify potential answers. A bud produced from a table may have a lower ranking than a bud based on a sentence found in visible or hidden text of a resource. A resource may provide answers which include unresolved pronouns and/or generic references. If a response includes this type of reference or anaphora a response including anaphora may be presented including context if it is a highest ranking potential response.

Answers extracted from a resource may be compared to stored information of answers. If an answer is determined to duplicate an existing answer a comparison is performed to determine which answer is superior. An answer may be assigned to a request or query based on a match to an existing answer associated with the query. A ranking or rating of an answer may be determined based on a selection of an answer by a responder. A ranking of a resource may be determined based on a number of answers, a percentage of answers, etc. associated with a keyword, topic, named entity, etc., obtained from a resource.

A system and method for assisting a person responding to queries is disclosed. Content of resources may be analyzed to present potential answers to a responder. User interfaces provided to a responder are determined based on a most probable type of information sought based on a request.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal. Further, according to an aspect of the embodiments, any combinations of the described features, functions and/or operations can be provided.

The many features and advantages of the claimed invention are apparent from the detailed specification and thus, it is intended by the appended claims to cover all such features and advantages of the claimed invention that fall within the true spirit and scope of the invention. Further, since numerous modifications and changes will readily occur to those skilled in the art, it is not desired to limit the invention to the exact construction and operation illustrated and described for the disclosed embodiments, and accordingly all suitable modifications and equivalents may be resorted to, falling within the scope of the claimed invention. It will further be understood that the phrase “at least one of A, B and C” may be used herein as an alternative expression that means “one or more of A, B and C.”

What is claimed is:

1. A computer-implemented method comprising:
receiving a request;
associating, by a processor, a category with the request based on an analysis of a corpus of requests;
associating an element of an index with the request based on a match of the request to a noun phrase; and
providing a response to the request based on the index.

2. The method of claim 1 further comprising:
associating elements of the index with noun phrases;
linking the element with a resource; and
increasing a ranking of the resource for the request when the request indicates the noun phrase.

3. The method of claim 1 further comprising:
assigning a weight to the element; and
determining a ranking of a resource for the request based on the weight.

4. The method of claim 1 further comprising:
assigning weights to elements of the index; and
determining a ranking of a responder based on the weights and named entities associated with the responder.

5. The method of claim 1 further comprising:
assigning elements of the index to noun phrases;
selecting an item based on a ranking of the item for the noun phrase when the item is associated with the noun phrase; and
selecting an item based on a ranking of the item for the element when the element is a highest weighted element associated with the request.

6. The method of claim 1 further comprising:
creating a group of noun phrases based on analysis of a corpus of resources;
selecting the noun phrase from the group based on frequency of use of the noun phrase in a set of queries; and
associating the element with the named entity based on an action by a human assistant.

7. The method of claim 1 further comprising:
associating a portion of the corpus with the category;
creating a filter based on the corpus using a Bayesian predictor; and
associating the category with the query when the filter indicates that the request indicates the category.

8. The method of claim 1 further comprising:
selecting a resource based on a ranking of the resource by a search engine for a query including the noun phrase and the element; and
obtaining the response based on content of the resource.

9. The method of claim 1 further comprising:
selecting an item based on the category when a corpus of noun phrases does not match the request; and
obtaining the response based on the item.

10. The method of claim 1 further comprising:
associating a resource with the element when the resource indicates the noun phrase; and
obtaining an answer from the resource based on a ranking of the resource for the element.

11. The method of claim 1 further comprising:
obtaining a corpus of noun phrases;
associating items with the noun phrases;
presenting an item associated with the element when the request includes a noun phrase that is associated with the element and the noun phrase is not associated with the items.

12. The method of claim 1 further comprising:
obtaining a corpus of noun phrases;
associating responders with the noun phrases; and
selecting a responder associated with the element when the request includes a noun phrase that is associated with the element and the noun phrase is not associated with the responders.

13. A system comprising:
a user device submitting a request; and
a search system device associating a category with the request based on an analysis of a corpus of requests, associating an element of an index with the request based on a match of the request to a noun phrase, and providing a response to the request based on the index.

14. The system of claim 13 further comprising:
a responder device receiving the request based on a ranking of the responder device for the category and the element.

15. A non-transitory computer readable storage medium storing therein an instruction for causing a computer to execute an operation, comprising:
receiving a request;
associating a category with the request based on an analysis of a corpus of requests;
associating an element of an index with the request based on a match of the request to a noun phrase; and
providing a response to the request based on the index.

16. The computer readable storage medium of claim 15 wherein the operation further comprises:
delivering the request to a human assistant;
presenting a user interface to the human assistant based on a type determined for the request;
obtaining the response based on a highest ranking resource for the request; and
providing the response when the human assistant disambiguates the response.

17. The computer readable storage medium of claim 15 wherein the operation further comprises:
associating elements of the index with noun phrases;
linking the element with a resource;
increasing a ranking of the resource for the request when the request indicates the noun phrase; and
obtaining a sentence from the resource as the response.

18. The computer readable storage medium of claim 15 wherein the operation further comprises:
assigning a weight to the element;
determining a ranking of a resource for the request based on the weight; and
presenting an interface to a human assistant based on the element.

19. The computer readable storage medium of claim 15 wherein the operation further comprises:
creating a group of noun phrases based on analysis of a corpus of resources;
selecting the noun phrase from the group based on frequency of use of the noun phrase in a set of queries;
associating the element with the named entity based on an action by a human assistant; and
choosing the human assistant based on a resource from which the noun phrase was selected.

20. The computer readable storage medium of claim 15 wherein the operation further comprises:
presenting a user interface identifying an ambiguous element of an answer to a human assistant; and
providing the response based on an action of the human assistant which disambiguates the element.
